(19) United States
(12) Patent Application Publication
(10) Pub. No.: US 2025/0229174 A1
(43) Pub. Date: Jul. 17, 2025

(54) EVENT SIGNAL TRANSMISSION ACROSS SERVERS ORGANIZED BY SURFACE TOPOLOGY

(71) Applicant: Tencent Technology (Shenzhen) Company Limited, Shenzhen (CN)

(72) Inventor: Boyuan Pan, Shenzhen (CN)

(21) Appl. No.: 19/095,572

(22) Filed: Mar. 31, 2025

Related U.S. Application Data
(63) Continuation of application No. PCT/CN2024/076909, filed on Feb. 8, 2024.

(30) Foreign Application Priority Data
Mar. 31, 2023 (CN) 202310363625.3

(51) Int. Cl. A63F 13/352; A63F 13/335

(52) U.S. Cl. CPC A63F 13/352; A63F 13/335; A63F 2300/407

(57) ABSTRACT

Aspects herein describe a method for improving event signal transmission across a plurality of zone servers organized based on surface topology. The method comprises determining, for an event signal from a first zone server in a service zone server set, a topology propagation path of the event signal in the service zone server set, and transmitting the event signal from the first zone server to the second zone server along the topology propagation path. Aspects herein further provide for transmitting the event signals for virtual objects across zone servers and improved cross-zone-server interaction. Aspects herein further provide for improved interaction efficiency and message transmission efficiency based on cross-zone-server transmission of event signals.

### CROSS-REFERENCE TO RELATED APPLICATIONS

This application is a continuation application of PCT Application PCT/CN2024/076909, filed Feb. 8, 2024, which claims priority to Chinese Patent Application No. 202310363625.3, filed on Mar. 31, 2023, each entitled “EVENT SIGNAL TRANSMISSION METHOD AND APPARATUS, COMPUTER DEVICE, AND STORAGE MEDIUM”, and each of which is incorporated herein by reference in its entirety.

### FIELD

Aspects described herein relate to the field of computer technologies, and in particular, to an event signal transmission method.

### BACKGROUND

With the development of computer technologies, users can open clients on terminals at any time to enter virtual worlds provided by the clients. Currently, a user needs to select a zone server to which an account of the user logs in, so as to enter a virtual world through the zone server. The zone server is a server of a zone, and each zone server is configured to process a service of one virtual sub-world in a virtual world.

### SUMMARY

Aspects described herein provide an event signal transmission method and apparatus, a computer device, and a storage medium, to improve transmission efficiency of event signals. The technical solutions are as follows:

According to one aspect, an event signal transmission method is provided. The method is executed by a server. The method includes: determining, for an event signal configured to a first zone server in a service zone server set, a topology propagation path of the event signal in the service zone server set based on a preset propagation parameter of the event signal, the topology propagation path being a propagation path from the first zone server to a second zone server in the service zone server set, the second zone server being specified by the first zone server or being determined from the service zone server set based on the preset propagation parameter, and the preset propagation parameter indicating at least one of a propagation direction or a propagation mode of the event signal; and transmitting the event signal from the first zone server to the second zone server along the topology propagation path.

According to one aspect, an event signal transmission apparatus is provided. The apparatus includes: a determination module, configured to determine, for an event signal configured to a first zone server in a service zone server set, a topology propagation path of the event signal in the service zone server set based on a preset propagation parameter of the event signal, the topology propagation path being a propagation path from the first zone server to a second zone server in the service zone server set, the second zone server being specified by the first zone server or being determined from the service zone server set based on the preset propagation parameter, and the preset propagation parameter indicating at least one of a propagation direction or a propagation mode of the event signal; and a transmission module, configured to transmit the event signal from the first zone server to the second zone server along the topology propagation path.

According to one aspect, a computer device is provided, including one or more processors and one or more memories, the one or more memories having at least one computer program stored therein, and the at least one computer program being loaded and executed by the one or more processors to cause the computer device to implement the foregoing event signal transmission method.

According to one aspect, a non-volatile computer-readable storage medium is provided, having at least one computer program stored therein, the at least one computer program being loaded and executed by a processor to cause the computer device to implement the foregoing event signal transmission method.

According to one aspect, a computer program product is provided, including one or more computer programs, the one or more computer programs being stored in a non-volatile computer-readable storage medium. One or more processors of a computer device are capable of reading the one or more computer programs from the non-volatile computer-readable storage medium, and the one or more processors execute the one or more computer programs, so that the computer device can perform the foregoing event signal transmission method.

According to aspects described herein, the preset propagation parameter is customized for the event signal, and the topology propagation path of the event signal can be determined according to the preset propagation parameter, thereby ensuring that the event signal can be transmitted between different zone servers, and implementing transmission of the event signal across zone servers. In this way, even if a virtual object controlled by a user is located in different zone servers in a virtual world, the user can perform interaction across zone servers through transmission of the event signal across zone servers, thereby improving interaction efficiency, interaction experience of the user, and a human-computer interaction rate. In addition, because a message can be transmitted by using an event signal as a carrier, the message transmission efficiency can be greatly improved.

### BRIEF DESCRIPTION OF THE DRAWINGS

FIG. 1 is a schematic diagram of an implementation environment of an event signal transmission method according to aspects described herein;

FIG. 2 is a schematic diagram of a topology space of a virtual world according to aspects described herein;

FIG. 3 is a schematic diagram of zone server expansion in a virtual world according to aspects described herein;

FIG. 4 is a flowchart of an event signal transmission method according to aspects described herein;

FIG. 5 is a flowchart of an event signal transmission method according to aspects described herein;

FIG. 6 is a diagram of a propagation topology of a diffusion event signal according to aspects described herein;

FIG. 7 is a diagram of a message transmission mechanism of a diffusion event signal according to aspects described herein;

FIG. 8 is a flowchart of an event signal transmission method according to aspects described herein;

FIG. 9 is a diagram of a propagation topology of a one-way transmission event signal according to aspects described herein;

FIG. 10 is a flowchart of an event signal transmission method according to aspects described herein;

FIG. 11 is a structural diagram of a topology within a zone server according to aspects described herein;

FIG. 12 is a flowchart of an event signal transmission method according to aspects described herein;

FIG. 13 is a flowchart of a zone server expansion method according to aspects described herein;

FIG. 14 is a schematic structural diagram of an event signal transmission apparatus according to aspects described herein;

FIG. 15 is a schematic structural diagram of an event signal transmission apparatus according to aspects described herein; and

FIG. 16 is a schematic structural diagram of a computer device according to aspects described herein.

### DETAILED DESCRIPTION

According to aspects described herein, the terms “first”, “second”, and the like are used for distinguishing between same items or similar items that have basically same effects and functions. “First”, “second”, and “n^{th}” do not have logical or time sequence dependency, and a quantity and an execution sequence are not limited either. The term “at least one” refers to one or more, and “a plurality of” refers to two or more. For example, a plurality of nodes refers to two or more nodes. The term “including at least one of A or B” involves the following several cases: including only A, including only B, and including both A and B.

User-related information (including but not limited to device information, personal information, behavior information, and the like of a user), data (including but not limited to data used for analysis, stored data, displayed data, and the like), and a signal in an implementation are all licensed, approved, authorized by the user, or fully authorized by all parties when aspects described herein are applied to a specific product or technology, and collection, use, and processing of the related information, the data, and the signal need to comply with related laws, regulations, and standards of a related country or region. For example, event signals in an implementation are all obtained under full authorization.

Cloud Gaming: Cloud gaming may be referred to as gaming on demand, and is an online game technology based on a cloud computing technology. The cloud gaming technology enables a thin-client device with a limited graphics processing and data operation capability to run a high-quality game. In a cloud gaming scenario, a game does not run in a game terminal of a player, but may instead run in a cloud server. The cloud server renders the gaming scenario to video and audio streams, and transmits the video and audio streams to the game terminal of the player through a network. The game terminal of the player does not need to have a powerful graphics operation and data processing capability, and instead only needs to have a basic streaming media playback capability and a capability of obtaining an instruction inputted by the player and sending the instruction to the cloud server.

The virtual world may be any world in which a virtual object performs activities. The virtual world may be a virtual world in a game, a virtual reality (VR)/augmented reality (AR) virtual world, or the like. According to an aspect, a virtual world in a game may also be referred to as a game world, a game-based open world, or the like.

A conventional game is a game world which may have boundaries and limitations built based on classic mechanics. Due to computing capability limitations, service data of all players may not be placed in a same server for a service logic operation. Therefore, the service data of the players may be dispersed and isolated to a plurality of zone servers. The service data of the players in different zone servers is independent of each other, which may make it difficult for players to have cross-zone-server service interactions. A conventional game may also have a global clock in a system background, which may require different servers to stay synchronized with the global clock. This is similar to the concept of “absolute time” in classic mechanics. At the same time message transmissions in a conventional game may be delayed, and a duration of the delay may not have an upper limit.

In a conventional game, a user (e.g., a player) may need to select a zone server when accessing a game service, then log into the zone server with an account of the user, so as to enter a virtual world of the game. In this way, data of different zone servers is isolated from each other. Virtual objects controlled by different users logging into a virtual world of a game from different zone servers do not meet each other even in the same location in the virtual world of the game. There is no cross-zone-server interaction mechanism between users, interaction efficiency is low, and user interaction experience is easily degraded, which may reduce user interaction time. According to an aspect

A game-based (for example, a cloud game) open world is may be used for illustrative purposes in aspects described herein. The open world is derived from principles of special relativity in modern physics, and departs from conventional game world views and space-time views. In the open world, a global uniform clock does not need to be maintained between different zone servers. Instead, each zone server only needs to be used as an independent node in the game world and maintains its own clock as a local inertial frame. In addition, the special relativity theory indicates that a speed of light has an upper limit; therefore, message transmission speeds may limited based on the upper limit of the speed of light. As a result, message transmission processes may be used as a part of a game mechanism in the open world, and may not be processed as a delay. Such game-based (for example, cloud game) open world can transcend boundaries and limitations of conventional games.

Terms used for aspects described herein are described below.

Game: A game is also referred to as an internet game or an online game. A game may be a multiplayer online game using the Internet as a transmission medium and a server as a processing terminal. For the purposes of the following description, a game described herein may be derived from principles of special relativity in modern physics, and departs from the game world view in the related technology. A basic principle of the game world view is as follows:
1. Time relativity and local inertial reference frame: In conventional games, servers (e.g., zone servers) of a game have a global clock (e.g., a virtual time zone), and need to keep the clock synchronous across servers. This is similar to absolute time in classic mechanics. However, in aspects described herein, a global uniform clock may not need to be maintained. Instead, each independent server in the game may use itself as a local inertial reference frame and maintain its own clock. For example: A first zone server maintains a first clock. The first clock may be set to 24 hours. A second zone server maintains a second clock. The second clock is set to 48 hours. The first clock and the second clock are different clocks. According to an aspect The inertial reference frame may also be referred to as an inertial frame.
2. Principle of invariant light speed: In conventional games, an information transmission time is processed as a delay and is not used as a process of the game, and it is assumed in game logic that an information transmission speed is unlimited. However, the narrow relativity theory indicates that a light speed has an upper limit, which also indicates that an information transmission speed is limited. The information transmission process may also be used as a part of a game. For example: if a player moves from the first server to the second zone server, the movement process is also used as a part of the game.

Virtual world: A virtual world is a virtual environment displayed (or provided) when a game client runs on a terminal. The virtual world may be a simulated environment of a real world, or may be a semi-simulated semi-fictional virtual environment, or may be an entirely fictional virtual environment. The virtual world may be any one of a 2-dimensional virtual world, a 2.5-dimensional virtual world, or a 3-dimensional virtual world. A user may control a virtual object to move in the virtual world.

Virtual object: A virtual object is a movable object in the virtual world. The virtual object may be a player character controlled by a user through a game client, or a non-player character (NPC) that is set in the virtual world and can interact, or a wild monster or a companion robot that is not controlled by a user, or the like. The virtual object may be a virtual avatar, such as a virtual character, a virtual animal, or an animation character used to represent a user in the virtual world. The virtual world may include a plurality of virtual objects, and each virtual object has a shape and a volume in the virtual world, and occupies some space in the virtual world. According to an aspect, when the virtual world is a 3-dimensional virtual world, the virtual object is a 3-dimensional model, and the three-dimensional model is a 3-dimensional character built based on a 3-dimensional human skeleton technology. The same virtual object may show different external appearances by wearing different skins. According to an aspect, the virtual object may be alternatively implemented by using a 2.5-dimensional model or a 2-dimensional model. Types, appearances, dimensions, and/or other characteristics of virtual objects are not limiting.

Virtual element: A virtual element refers to various virtual elements appearing in the virtual world, and is used to constitute the entire virtual world. The virtual element includes plots, lakes, the sky, various virtual animals, various virtual plants, various virtual buildings, various virtual props, and the like. A virtual object controlled by a player is also one of world elements.

Graphics processing unit (GPU): A graphics processing unit is a dedicated chip applied to a modern personal computer, a server, a mobile device, or a game host to specially process a graphic image.

Service zone server set: In a conventional game, service logic of a game service is implemented by using a zone server as a unit, wherein the zone server is a server of a zone. A zone server is configured to process a game service of one virtual sub-world in a virtual world. For example, a game server is divided into a plurality of large-zone servers, and each large-zone server is further subdivided into a plurality of zone servers. Division standards of large-zone servers and zone servers are usually different. For example, a game server is divided into different large-zone servers according to authorized login channels of game accounts, and each large-zone server is divided into a plurality of zone servers according to geographical locations, wherein player data of different zone servers is isolated from each other. However, according to aspects described herein, player data between different zone servers is no longer isolated because a message transmission mechanism across zone servers is provided, and all zone servers of a game service may be referred to as a service zone server set.

Zone server: A service zone server set for deploying a virtual world includes a plurality of zone servers, and each zone server may be implemented as one or more servers (e.g., a server cluster). The zone server is also referred to as a server or a node. Zone servers may not be directly connected to each other in the physical world, and instead are logically connected to each other by using a message transit node. Each zone server can transmit a message only to another zone server that is logically connected to the zone server, but cannot transmit a message to another zone server that is not logically connected to the zone server.

In an example, an entire virtual world of a game may be represented as a ball (for example, a soccer ball). The virtual world includes a plurality of zone servers (for example, each pentagonal region on the soccer ball) that independently run. The plurality of zone servers may be distributed on a surface of the virtual world (e.g., the soccer ball). Each zone server extends outward and is communicatively connected to a limited quantity of other zone servers by using a message transit node. Each zone server (or the message transit node) and each adjacent node have a message transmission path, that is, are connected through a signal line in the physical world, and may receive and send messages to each other.

Computing unit: One zone server (node) is divided into a plurality of units, and one zone server includes a plurality of computing units. Each computing unit may be implemented as a central processing unit (CPU) or a GPU on any server of zone servers in which the computing unit is located. Each computing unit has an associated sub-region in a shared storage region shared by a plurality of computing units of a server in the physical world. The plurality of parallel computing units in the zone server are similar to a plurality of parallel computing cores in the GPU. Message transmission between computing units may be implemented through the shared storage region. All computing units in a zone server have a shared clock and are in the same virtual time zone. Due to the close proximity of computing units, relativity effects can be ignored and classical mechanics may be applied. Therefore, according to this definition, all events and/or game elements (e.g., virtual elements) of computing units of the same zone server may run based on the same clock, even if they occur at different places in the same zone server.

Message transit node: In a cloud game architecture, a message transit node is further provided. The message transit node provides a message transit function between different zone servers externally, but may not provide game service logic operations. The message transmit node may not represent a zone server nor a computing unit.

Event: An event is the basis of running of an entire game world. Similar to description of events in the relativity theory, because of time relativity, objective facts in the game world may be expressed as “an event happens at a time and a place in an inertial frame”. That is, an event happens at [x, y, z, t] in a selected inertial frame, where x, y, and z are respectively coordinate values in three directions of x, y, and z in an inertial frame, and t is a time recorded by a shared clock in the inertial frame.

In view of this, an event in a game world may further include an attribute (for example, what type of event) of the event, a node in which the event is located (which selected inertial frame, or in other words, which zone server), a logical position in the node (spatial positions x, y, and z in the selected inertial frame), and a time in the node (a time t in the selected inertial frame). Therefore, an event may be described by at least the following vector [what, which, where, when], and the vector is referred to as an event description vector.

In an example, a virtual element in a game world may also be abstracted as an event: a virtual element, a node, a logical location in the node, and a time in the node. A virtual element only differs from an event in that the virtual element is rendered in the game world and may be seen by a user. The event and the virtual element may interact with each other. The event may generate a virtual element, and the virtual element may also generate an event. This is similar to a relationship between mass and energy in modern physics. An event is more like virtual energy, and a virtual element is more like virtual mass. In other words, an event corresponds to at least one of virtual energy and virtual mass. The event may include at least one of: a one-way transmission event and a diffusion event.

Diffusion event: A diffusion event is an event with no fixed direction, has virtual energy, and has no virtual mass. A diffusion event may be sent toward all nodes directly connected to a current node (e.g., a inertial frame in which the diffusion event is located), and virtual energy thereof attenuates as a propagation distance increases. If there is no attenuation, the diffusion event permanently transmits in the game world and does not disappear.

One-way transmission event: A one-way transmission event is an event that has a fixed direction and a traversal termination condition, has traversal energy, and has virtual mass. The traversal energy of a one-way transmission event attenuates as propagation distance increases, but the virtual mass of the one-way transmission event does not attenuate as a propagation distance increases.

The following describes a system architecture which may be used to implement aspects described herein. Other system architectures may also be used.

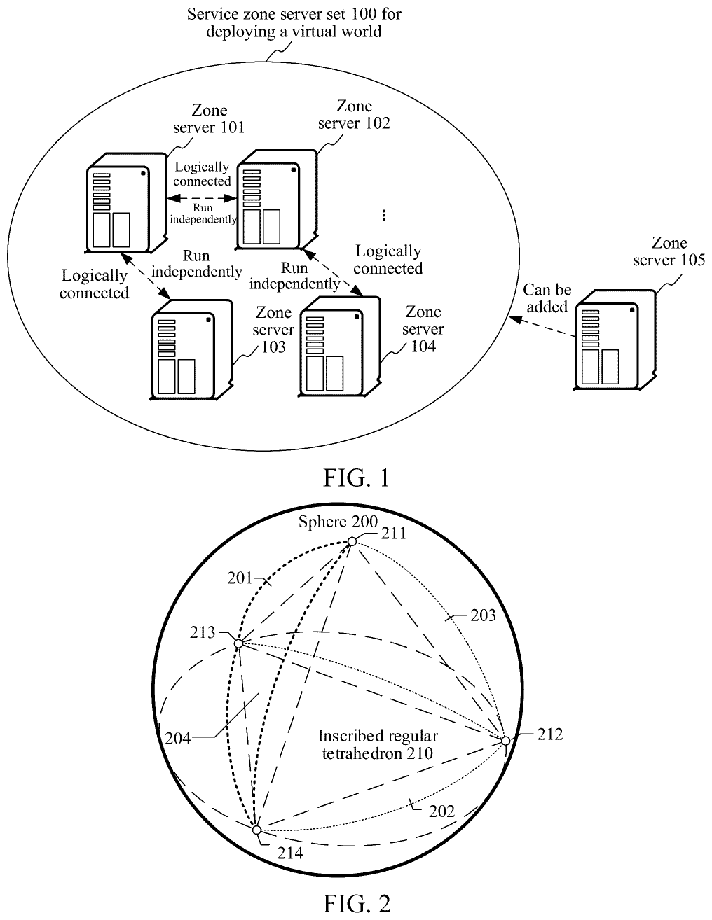

FIG. 1 is a schematic diagram of an implementation environment of an event signal transmission method according to aspects described herein. As shown in FIG. 1, in a virtual world based on a cloud game according to aspects described herein, at least one zone server that runs independently is deployed, and each zone server is hosted by one or more servers (e.g., server cluster) in the physical world. Each zone server may be hosted by: an independent physical server, a server cluster comprising a plurality of physical servers or a distributed system, or a cloud server providing basic cloud computing services such as a cloud service, a cloud database, cloud computing, a cloud function, cloud storage, a network service, cloud communication, a middleware service, a domain name service, a security service, a content delivery network (CDN), a big data platform, and/or an artificial intelligence platform. The method of zone server hosting is not limited.

For example, a service zone server set 100 used for deploying a virtual world comprises zone server 101, zone server 102, zone server 103, and zone server 104. Service zone server set 100 is also referred to as a cloud game server or a cloud game system. Each zone server in the service zone server set 100 is logically connected to at least one other zone server in the set. For example, the zone server 101 is logically connected to the zone server 102 and the zone server 103, and the zone server 102 is logically connected to the zone server 101 and the zone server 104. In this example, the zone server 101 can send data to the logically connected zone server 102 and/or zone server 103, but may not be able to directly send data to the zone server 104. According to aspects described herein, different zone servers in the service zone server set 100 may not have a unified global clock. As a local inertial frame, each zone server only needs to maintain a clock for computing units within the zone server.

If an event is generated in a specific zone server and an event signal of the event is not transmitted to another zone server, the event signal of the event does not affect running of the another zone server. When the event signal of the event is transmitted to the another zone server, the event signal of the event participates in a service logic operation of the another zone server. For example, when an event is generated in the zone server 101 and an event signal of the event is not transmitted to the zone server 102, the event signal of the event does not affect running of the zone server 102. When the event signal of the event generated in zone server 101 is transmitted to the zone server 102, the event signal of the event participates in a service logic operation of the zone server 102. The event signal is a signal used for carrying an event, and the event may be transmitted (or referred to as propagated, sent, or transmitted) between different zone servers in a form of the event signal.

For example, the Big Bang theory states that the universe is expanding continuously and galaxies are moving away from each other. Similar to the Big Bang theory, “expansion” is a basic property of a virtual world based on a cloud game according to aspects described herein. Because the virtual world may be continuously expanding, a topology relationship between zone servers is dynamic. This is very different from a conventional game. In the conventional game, a number of zone servers is derived from external human influence, not as a basic property of the game, and a quantity and a topology relationship of zone servers are static. If the zone servers reach a service upper limit, players may be forced to wait until a human can add more servers or other players log off.

Based on this, when a service zone server set, such as service zone server set 100, satisfies a zone server expansion condition, each zone server may be split to generate a new zone server and a message transit node associated with the new zone server. The new zone server is added to a virtual world: for example, adding the new zone server to the service zone server set 100. The new zone server added to the virtual world does not affect an existing zone server unless an event signal in the new zone server is transmitted to the existing zone server. For example, the new zone server is zone server 105. When zone server 105 is added to the service zone server set 100, zone server 105 does not affect the zone server 101, the zone server 102, the zone server 103, and the zone server 104. Assuming that the zone server 105 is logically connected to the zone server 101, zone server 101 may only be affect when an event signal in the zone server 105 is transmitted to the zone server 101.

In the virtual world based on the cloud game according to aspects described herein, each zone server only needs to calculate and maintain information transmitted to the zone server. Each zone server does not need to care about data in another zone server, nor synchronize data in another zone server, and nor maintain a global clock between different zone servers. Expansion of a quantity of zone servers in a game world is not limited by a computing capability of the zone servers, allowing for the virtual world to be expanded as necessary.

In a cloud game framework, a user may experience a cloud game by using a terminal. However, a game client on a terminal side only plays and displays a game picture stream, and does not participate in service logic operation and game picture rendering. The cloud game actually runs on a cloud game server, and the game client on the terminal side only provides a simple operation instruction receiving and sending function and a simple game picture stream playing function. According to an aspect, the terminal may be a smartphone, a tablet computer, a notebook computer, a desktop computer, a smart speaker, a smartwatch, or the like, but is not limited thereto. The terminal and the server may be directly or indirectly connected in a wired or wireless communication manner.

Further description is made based on FIG. 1. A virtual world may be abstracted as a sphere in a topology space, wherein zone servers in the virtual world are distributed on a surface of the sphere. A zone server extends outward for a limited quantity of communication connections, is hosted by one or more servers (e.g., server cluster), and internally maintains a clock period of an inertial frame of the zone server. In a possible implementation, zone servers are not directly connected to each other. That is, in addition to the zone servers, a plurality of message transit nodes (not shown in FIG. 1) are also distributed on the surface of the sphere. Each message transit node is connected to one or more zone servers and/or other message transit nodes. A message transit node may be configured to transmit an event signal and may not participate in a service logic operation of the cloud game; that is, a player character does not run in the message transit node. Both the message transit node and the zone server are “nodes” in a virtual world, and the message transit node and the zone server jointly form a cloud game world.

In a virtual world, an event signal used to carry an event may be propagated along the surface of the sphere, wherein an event signal generated by each zone server can only be directly transmitted to an adjacent node (for example, an adjacent zone server or an adjacent message transit node). The zone server and the message transit node can both receive, send, and/or process an event signal. An event signal propagates in a virtual world at a limited speed, and a propagation speed is a speed at which these nodes perform receiving and sending processing on the event signal. Because different nodes may have different processing speeds for the event signal, propagation speeds of the event signal in different nodes are not necessarily the same.

Events carried in event signals are classified into two types: a one-way transmission event and a diffusion event. The one-way transmission event is transmitted to a determined connection direction, traversal energy of the one-way transmission event attenuates in a propagation process, but virtual mass does not attenuate in the propagation process. The diffusion event is transmitted to all connection directions and has no virtual mass, and virtual energy of the diffusion event attenuates in the propagation process. For example, traversal behaviors of a virtual object controlled by a player and wherein the traversal behaviors are in different zone servers of a game world may be processed as a one-way transmission event. During the transmission process, the virtual object is used as an event signal, and is transmitted in the virtual world like energy. Because a virtual world has an attribute of spontaneous expansion, the virtual world automatically expands according to a specified rule (e.g., a specified zone server expansion condition). A virtual object controlled by a player may be born in an existing zone server whose capacity is not full, or may be born in a new zone server generated through expansion. Both the physical world and the topology sphere may expand. A new zone server and a new message transit node are generated in nodes obtained after an existing zone server expands. Therefore, the new zone server may be selected from the nodes obtained after the existing zone server expands. The new zone server generated after expansion is only connected to a surrounding node, and does not change a connection relationship between non-adjacent nodes. Because the zone server is distributed like a region on the surface of a soccer ball both physically and logically, the following can be implemented: A game world infinitely expands, a quantity of zone servers infinitely expands, and virtual objects are infinitely increased. In addition, all virtual elements in the game world can run and interact simultaneously, and are transmitted within a zone server or across zone servers.

A topology space of a virtual world that may be implemented is described below with reference to FIG. 2 as an example. As shown in FIG. 2, when a virtual world is initialized, an inscribed regular tetrahedron 210 is found based on a sphere 200 in a topology space, and 4 vertexes 211 to 214 of the inscribed regular tetrahedron 210 are respectively used as boundary vertexes of 1 zone server and 3 message transit nodes. For any two boundary vertexes, a large arc passing through the two boundary vertexes can be found on a spherical surface (that is, the surface of the sphere). The “large arc on the spherical surface” herein refers to an intersection line between a plane passing through the spherical center on the spherical surface and the spherical surface. The spherical surface can be divided into 1 zone server and 3 message transit nodes by using a large arc between vertexes as a boundary. In a possible division manner, the spherical surface is divided into zone server 201 and message transit nodes 202, 203, and 204. For example, 3 large arcs with bold form a boundary of the zone server 201, a part surrounded by the large arcs on the spherical surface is the zone server 201, and parts jointly surrounded by the large arcs with bold and the remaining large arcs respectively form the message transit nodes 202, 203, and 204. The “zone server” and the “message transit node” both refer to closed regions formed by large arcs on the spherical surface, rather than boundary vertexes. In this way, it can be seen that a topology distribution manner between the zone server and the message transit node is similar to that planets are dispersed in cosmic space.

In a virtual world, an event signal can be transmitted only across a boundary on the spherical surface, and cannot be transmitted out of the spherical surface (for example, an event signal may not pass through the inside of the sphere). For example, each zone server or message transit node may have a message transit path to three adjacent nodes (which may be other zone servers or message transit nodes). Two physical machines (e.g., a hosting server or server cluster) of two nodes having a message transit path are connected to each other through a signal line, and can mutually receive and send information such as an event signal.

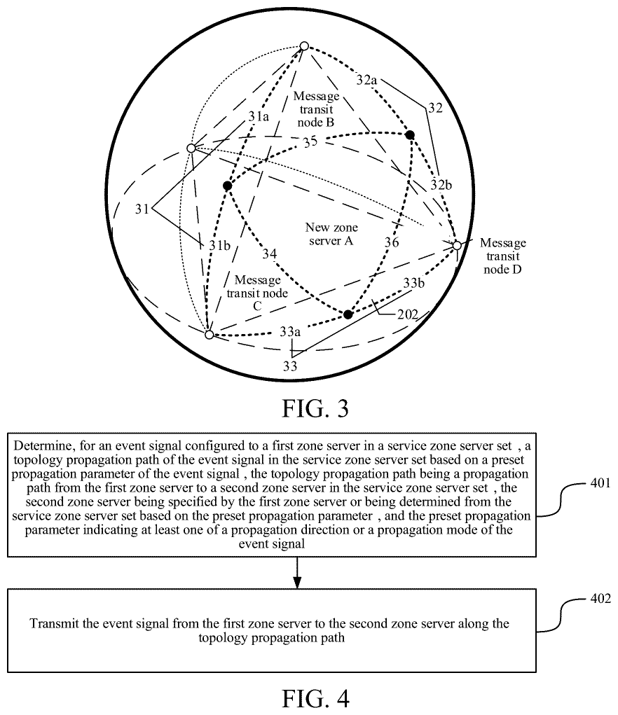

FIG. 3 depicts a zone server expansion process. As shown in FIG. 3, a zone server and a message transit node in a game world can generate more zone servers and message transit nodes in a manner similar to splitting. Using a boundary of a message transit node 202 as an example, the boundary of the message transit node 202 includes three large arcs 31, 32, and 33. A midpoint of each large arc may be used as a new boundary vertex. In this way, connection between the three boundary vertexes generates new large arcs 34, 35, and 36. In this way, an original boundary of the message transit node 202 is naturally divided into two. For example, the large arc 31 is divided into two segments 31a and 31b by using a midpoint as a boundary. Similarly, the large arc 32 is divided into two segments 32a and 32b, and the large arc 33 is also divided into two segments 33a and 33b. In this way, a part that is enclosed on the spherical surface by the new large arcs 34, 35, and 36 and 31a, 31b, 32a, 32b, 33a, and 33b forms a new zone server A and three new message transit nodes B, C, and D. Each time a zone server (or a message transit node) is split into four parts on the spherical surface, a central part may be used as the zone server, and surrounding parts may be used as message transit nodes. In this way, both an existing zone server and an existing message transit node can be repeatedly split in a same manner to generate new nodes, so that a virtual world can expand infinitely. From the perspective of surface area, this splitting manner seems to have no expansion (that is, a volume of the sphere is not increased). However, because a message transmission speed between two nodes is constant, splitting into more small blocks (e.g., new zone servers) increases a message transmission path between zone servers, similar to how galaxies in a universe move away from each other. Therefore, in essence, the virtual world continuously expands.

The following describes a basic communication process between different zone servers in a virtual world with reference to FIG. 4.

FIG. 4 is a flowchart of an event signal transmission method according to aspects described herein. Referring to FIG. 4, the server is configured to process services of a virtual world. For example, the server may include a service zone server set for deploying a virtual world and may deploy the virtual world. The service zone server set is a set formed by all zone servers in the server, and may provide services to the outside. Therefore, the service zone server set may be considered as a server of a virtual world. The service zone server set includes at least two zone servers, and the at least two zone servers include a first zone server and a second zone server that are logically connected. Logically connecting the first zone server to the second zone server means that a signal or data may be transmitted between the first zone server and the second zone server. An event signal transmission method is described below by using an example in which the first zone server is used as a source node of an event signal and the second zone server is used as a destination node of the event signal. The event signal transmission method comprises operation 401 and operation 402:

401: Determine, for an event signal configured to a first zone server in a service zone server set, a topology propagation path of the event signal in the service zone server set based on a preset propagation parameter of the event signal. The topology propagation path may be a propagation path from the first zone server to a second zone server in the service zone server set, the second zone server being specified by the first zone server or being determined from the service zone server set based on the preset propagation parameter, and the preset propagation parameter indicating at least one of a propagation direction or a propagation mode of the event signal.

The event signal is a signal used for carrying an event. In other words, the event is transmitted (e.g., propagated, sent, transmitted, and/or others) between different zone servers in a form of the event signal. An event is a basic unit in which a virtual world runs. According to an aspect, an event may be an interactive operation. The interactive operation is an operation in which a user controls a virtual object to interact in a virtual world. For example, the interactive operation may be, but is not limited to: an operation of sending a message, a moving operation, an operation of firing a virtual prop, an operation of aiming at and shooting a position, an attack operation, a defense operation, and/or the like. According to an aspect, the interactive operation may be an interactive operation in a game. In this case, the event signal is a signal of the interactive operation in the game, for example, a signal of an operation of firing a virtual prop.

According to an aspect, a user may control, by using a game client on a terminal, a virtual object to perform an action (that is, an interactive operation) in the first zone server. The first zone server generates, according to action indication information provided by the game client, an event signal of an event generated by the action indication information. If the event only acts within the first zone server, the event signal only involves transmission between different computing units within the first zone server, or is directly processed on a current computing unit without interacting with another computing unit. If the event acts in the second zone server other than the first zone server, the event signal needs to be sent from the first zone server to the second zone server in the virtual world. Once the event signal reaches the second zone server, the event signal participates in a service logic operation of the second zone server; otherwise, the second zone server does not sense the event signal. A message transmission mechanism between different computing units within a zone server may be the same as a message transmission mechanism between different zone servers, and is described further below.

According to an aspect An event may affect the second zone server, wherein the second zone server is separate from the first zone server and wherein the event occurs in the first zone server. The second zone server is a zone server specified by the first zone server, or the second zone server may be a to-be-determined zone server that is unknown at present. A type of the event signal (corresponding to the event) may be divided into a diffusion event signal and a one-way transmission event signal based on whether the event signal points to a determined second zone server. The diffusion event signal does not point to the determined second zone server, and therefore does not have a specified propagation direction, and a propagation mode of the diffusion event signal in a topology space is similar to broadcast or multicast. The one-way transmission event signal points to the determined second zone server, and therefore has a specified propagation direction, and a propagation mode of the one-way transmission event signal in a topology space is similar to unicast.

Before the event signal is transmitted, a preset propagation parameter of the event signal needs to be first determined. The preset propagation parameter is used for indicating at least one of a propagation direction or a propagation mode of the event signal. The transmission direction is used to indicate a direction in which the event signal is propagated, and the propagation mode is used to indicate a mode in which the event signal is propagated. According to an aspect, the preset propagation parameter of the event signal may be configured by a technical person, or may be configured based on the type of the event signal.

The propagation mode is used to limit at least one propagation element in the propagation process, and the propagation element is a basic unit constituting the propagation process. For example, the propagation element may include at least one of a propagation process start condition, a propagation process termination condition, a quantity of propagations, a propagation direction change rule, and a propagation rate. Additionally or alternatively, when a propagation mode is used to limit the propagation process start condition and the propagation process termination condition, the propagation mode may refer to starting propagation based on an initial value of virtual energy and stopping propagation when the initial value of the virtual energy attenuates to a termination threshold. In another example, when the propagation mode is used to limit the propagation direction change rule of the propagation process, the propagation mode may refer to rotating clockwise a propagation direction of a previous propagation by 15 degrees for a propagation direction of a next propagation.

For example, when the preset propagation parameter of the event signal is configured based on the type of the event signal, determining the preset transmission parameter may comprise configuring, based on a type of the event signal, a preset propagation parameter matching the type of the event signal, wherein the type of the event signal is determined based on whether the event signal has a specified propagation direction. For example, the type of the event signal may be divided into a diffusion event signal and a one-way transmission event signal. The diffusion event signal does not have a specified propagation direction, and the one-way transmission event signal has a specified propagation direction.

The type of the event signal matches an event type of the event carried in the event signal. If the event type of the event carried in the event signal is a diffusion event, the type of the event signal is a diffusion event signal. If the event type of the event carried in the event signal is a one-way transmission event, the type of the event signal is a one-way transmission event signal. According to an aspect, the diffusion event signal may also be referred to as an event signal of a diffusion event, and the one-way transmission event signal may also be referred to as an event signal of a one-way transmission event.

When the preset propagation parameter of the event signal is configured based on the type of the event signal, determining a topology propagation path of the event signal in the service zone server set may be based on the preset propagation parameter of the event signal.

In this example, the first zone server can, based on the type of the event signal, configure the preset propagation parameter matching the type of the event signal. The preset propagation parameter indicates at least one of a propagation direction or a propagation mode of the event signal in a case of a suitable type of event signal.

Because the propagation direction of the diffusion event signal is not specified, and the propagation direction of the one-way transmission event signal is specified, the two different types of event signals have different propagation directions or propagation modes. A propagation direction or a propagation mode suitable for each type of event signal can be indicated by configuring the preset propagation parameter, allowing for different types of event signals to be transmitted across zone servers in the virtual world. Because a message can be transmitted by using an event signal as a carrier, message transmission efficiency can be improved.

According to an aspect, the first zone server may further determine a topology propagation path of the event signal in the service zone server set based on the determined preset propagation parameter. The topology propagation path is a path through which the event signal is propagated along a spherical surface representing the virtual world in a topology space. The topology propagation path is a path propagating along a surface of a topology structure, and the topology structure is a geometric structure formed by points and lines. The service zone server set may be abstracted as a topology structure, that is, a zone server in the service zone server set is abstracted as a point, and a transmission medium between zone servers in the service zone server set is abstracted as a line, and a structure formed by the point and the line is used as the topology structure. Zone servers in the service zone server set are distributed on the surface of the topology structure. The event signal can be propagated only across a boundary on the surface of the topology structure, and cannot be propagated off the surface of the topology structure (for example, pass through the inside of the topology structure). The propagation path of the event signal is referred to as the topology propagation path.

According to an aspect, the topology structure may be approximated as a sphere. The zone servers in the service zone server set are distributed on a surface of the sphere. The event signal can be transmitted only across a boundary on the surface of the sphere, and cannot be transmitted off the surface of the sphere (for example, pass through the inside of the sphere). According to another aspect, a space in which the topology structure is located may be referred to as a topology space, the topology structure may be considered as a sphere projected by the virtual world in the topology space, and the topology propagation path may also be understood as a path of propagating on a spherical surface projected by the virtual world in the topology space.

For a diffusion event signal, the topology propagation path usually has a plurality of branches, and each branch points to a second zone server. For a one-way transmission event signal, the topology propagation path usually has a unique branch, and the unique branch points to the second zone server. Determining topology propagation paths for different types of event signals may differ. Illustrative methods are described below.

According to an aspect, the second zone server may be specified by the first zone server. For example, if a user specifies that a virtual object is to be traversed from a first zone server to a second zone server, the traversal event has a specified second zone server (that is, the second zone server). Alternatively, the second zone server may be determined from the service zone server set based on the preset propagation parameter. For example, if a user publishes a reward notification for a specified virtual object, a reward event corresponding to the reward notification is broadcast along the topology propagation path until virtual energy of the reward event is insufficient.

402: Transmit the event signal from the first zone server to the second zone server along the topology propagation path.

For example, the event signal participates in a service logic operation of the second zone server after reaching the second zone server.

According to an aspect, after the topology propagation path is determined, the event signal is sent from the first zone server to the second zone server along the topology propagation path in a virtual world. In a topology space, the event signal is transmitted from a node representing the first zone server to a node representing the second zone server along a projection of the topology propagation path on the spherical surface. The event signal can participate in a service logic operation of the second zone server only after reaching the second zone server. The second zone server cannot sense the event signal before the event signal reaches the second zone server, and the second zone server does not need to wait for the event signal to reach because the event signal may encounter some obstacles and therefore cannot reach the second zone server. The first zone server and the second zone server are used as independent inertial frames, and each maintains a shared clock of different computing units within the server, but a global clock does not need to be maintained between the first zone server and the second zone server.

All the foregoing optional technical solutions can be combined in different manners according to aspects described herein. According to according to aspects described herein, a message transmission mechanism across zone servers using an event signal as a carrier is constructed between zone servers of a virtual world, the preset propagation parameter is customized for the event signal, and the topology propagation path of the event signal can be determined according to the preset propagation parameter, thereby ensuring that the event signal can be transmitted between different zone servers, and implementing transmission of the event signal across zone servers. In this way, even if a virtual object controlled by a user is located in different zone servers in the virtual world, the user can perform interaction across zone servers through transmission of the event signal across zone servers, thereby improving interaction efficiency, interaction experience of the user, and a human-computer interaction rate. In addition, because a message can be transmitted by using an event signal as a carrier, the message transmission efficiency can be greatly improved.

In addition, when customizing a preset propagation parameter for an event signal, different preset propagation parameters are customized for different types of event signals, so that the different types of event signals can all be transmitted across zone servers in a virtual world, and cross-zone-server transmission of a plurality of types of event signals is implemented, thereby enabling a user to perform cross-zone-server interaction through cross-zone-server transmission of a plurality of types of event signals, further improving interaction efficiency and user interaction experience, improving a human-computer interaction rate, and further improving message transmission efficiency.

When types of event signals are different, topology propagation paths of the event signals are also different; therefore, propagation procedures of a diffusion event signal and a one-way transmission event signal in a virtual world are described respectively below. When an event signal is transmitted between different zone servers, if the event signal does not include virtual mass, there are only energy attenuation and information transmission. If the event signal includes virtual mass, in addition to energy attenuation, there is usually transmission of a virtual element (the virtual element refers to an event that is rendered into a game picture, and is a special case of the event) between virtual sub-worlds. That is, the virtual element is traversed from a virtual sub-world of the first zone server to a virtual sub-world of the second zone server. Herein, the “virtual sub-world” is obtained by dividing the virtual world by using a zone server as a unit, and each zone server is uniquely associated with one virtual sub-world in the virtual world. The virtual element (including a native virtual element and a virtual element traversed from another virtual sub-world) included in a virtual sub-world is rendered into a game picture.

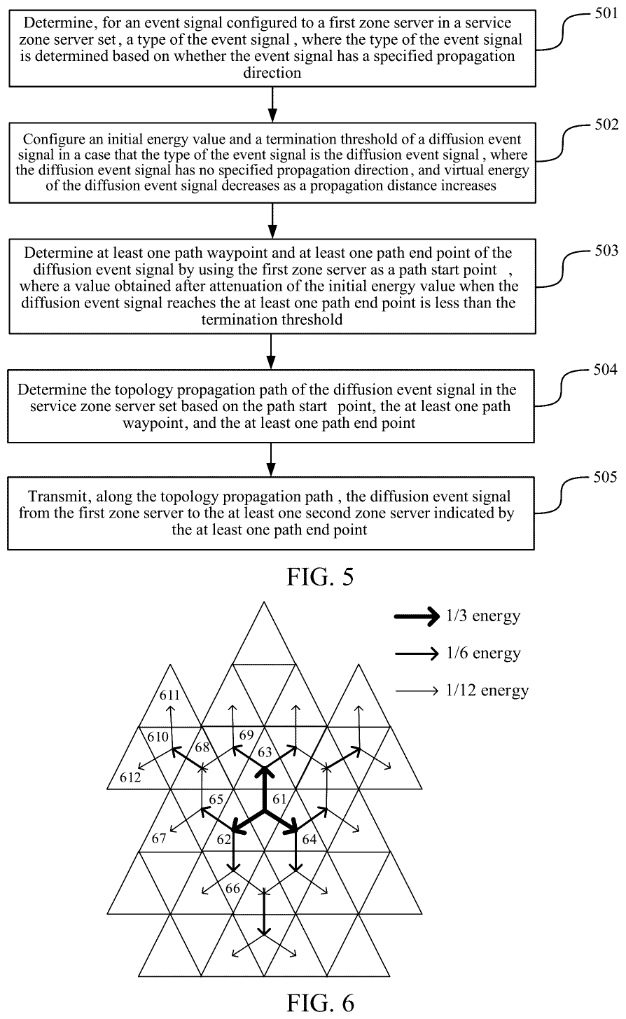

FIG. 5 is a flowchart of an event signal transmission method according to aspects described herein. Referring to FIG. 5, an event type of an event carried in an event signal is a diffusion event, and may have a diffusion event signal and a corresponding transmission mechanism based on the diffusion events signal. The service zone server set is a set formed by all zone servers in the service, and may provide services to the outside. Therefore, the service zone server set may be considered as a server for deploying a virtual world. The service zone server set comprises at least two zone servers, and each zone server in the service zone server set is uniquely associated with one virtual sub-world in the virtual world. The at least two zone servers include a first zone server and a second zone server that are logically connected. In the example described below, the first zone server is a source node of an event signal, and the second zone server is a destination node of the event signal. A transmission method for the diffusion event signal includes the following operation 501 to operation 505:

501: Determine, for an event signal configured to a first zone server in a service zone server set, a type of the event signal, where the type of the event signal is determined based on whether the event signal has a specified propagation direction.

According to an aspect, a user may control, by using a game client on a terminal, a virtual object to perform an action in the first zone server. The first zone server generates, according to action indication information provided by the game client, an event signal of an event generated by the action indication information. If the event only acts within the first zone server, the event signal only involves transmission between different computing units within the first zone server, or is directly processed on a current computing unit without interacting with another computing unit. If the event acts in the second zone server other than the first zone server, the event signal needs to be sent from the first zone server to the second zone server in the virtual world. Once the event signal reaches the second zone server, the event signal participates in a service logic operation of the second zone server; otherwise, the second zone server does not sense the event signal. According to another aspect, when the event acts in the second zone server the second zone server may be a zone server specified by the first zone server, or the second zone server may be a to-be-determined zone server. A type of the event signal may be divided into a diffusion event signal and a one-way transmission event signal according to whether the event signal clearly points to the determined second zone server. The diffusion event signal does not point to the determined second zone server, and therefore does not have a specified propagation direction, and a propagation mode of the diffusion event signal in a topology space is similar to broadcast or multicast. The one-way transmission event signal points to the determined second zone server, and therefore has a specified propagation direction, and a propagation mode of the one-way transmission event signal in a topology space is similar to unicast.

Based on this, after encapsulating an event into an event signal, the first zone server configures a type of the event signal according to whether the event signal has a specified propagation direction. When the event signal does not have the propagation direction specified by the first zone server, the type of the event signal is configured as a diffusion event signal. This indicates that this event signal does not point to the determined second zone server, and instead the second zone server is selected according to an attenuation status of virtual energy. When the event signal has the propagation direction specified by the first zone server, the type of the event signal is configured as a one-way transmission event signal. This indicates that the event signal points to a specific second zone server (but the event signal does not necessarily really reach the second zone server because a traversal termination condition may be satisfied in advance when the event signal traverses to a waypoint of the second zone server). In the following example, the type of the event signal is a diffusion event signal. An example in which the type of the event signal is a one-way transmission event signal will be described further below.

According to an aspect, when encapsulating a diffusion event into an event signal, the first zone server may describe the diffusion event by using an event description vector [what, which, where, when]. “What” represents an attribute (which event, or a type of event) of the event, “which” represents a node (which inertial reference frame, that is, which zone server) in which the event is located, “where” represents a logical position (spatial positions x, y, and z in the selected inertial frame) at which the event occurs in the node, and “when” represents a time (a time t in the selected inertial frame) at which the event occurs in the node.

According to an aspect, “what” in the event description vector records an event identification (ID), an event type, and a preset propagation parameter. The event ID is used for uniquely identifying an event (determined based on action indication information triggered by a user on the game client), the event type is used for indicating whether the event identified by the event ID is a diffusion event or a one-way transmission event, and the preset propagation parameter is used for indicating at least one of a propagation direction or a propagation mode of an event signal carrying the event. For an event signal carrying a diffusion event (that is, a diffusion event signal), the preset propagation parameter of the diffusion event signal includes at least an initial energy value and a termination threshold determined in the following operation 502.

According to an aspect, each zone server in the service zone server set pre-stores a mapping relationship table of an event ID and an event type to improve real-time calculation efficiency of the cloud game system. An event type of each event is indicated in the mapping relationship table by using a key-value pair data structure. For example, an event ID of each event is used as a key, and a type ID of the event type of each event is used as a value. In this way, after an event ID is determined according to the action indication information triggered by the user on the game client, the mapping relationship table is queried by using the event ID as an index. If the index can match any key-value data structure, a type ID in the value is obtained, and an event type indicated by the type ID. If the index does not match any key-value data structure, an error code may be returned. In an example, wherein event type may be limited to a diffusion event and a one-way transmission event, the type ID may be implemented as binary data or Boolean data. The binary data has a value of 1 or 0, and the Boolean data has a value of true or false. This exactly corresponds to two event types, thereby improving efficiency of determining an event type.

Further, the event ID and the type ID have different meanings. The event ID represents a type of an event, such as a type of in-game event. The type ID represents an event type of the event, such as a diffusion event or a one-way transmission event. Various events having different event IDs may have the same or different type IDs. For example, an event ID of a “reward event” is 001, an event ID of a “full-service chat” is 002, an event ID of a “firing event” is 003, and an event ID of a “traversal event” is 004. In this case, the “reward event” and the “full-service chat” have different event IDs, but have the same type ID (both belong to a diffusion event). Similarly, the “firing event” and the “traversal event” have different event IDs, but have the same type ID (both belong to a one-way transmission event). The “reward event” and the “traversal event” are further examined, and the “reward event” and the “traversal event” have different event IDs, and also have different type IDs. For example, when a type ID is Boolean data and a value of true is defined to represent a one-way transmission event and a value of false is defined to represent a diffusion event, type IDs of the “reward event” and the “full-service chat” both have a value of false, and type IDs of the “firing event” and the “traversal event” both have a value of true.

In addition to binary data and Boolean data, the type ID may also be implemented as another data type such as a character string, integer data, or floating point data. The implementation data type is not limiting. The mapping relationship table may also be implemented as another data structure, such as a hash table or a bitmap, and is also not limiting. Besides, in addition to the diffusion event and the one-way transmission event, more types of events may also be obtained through division in the cloud game system according to a service requirement, and are not enumerated herein.

502: Configure an initial energy value and a termination threshold of a diffusion event signal wherein the diffusion event signal has no specified propagation direction, and virtual energy of the diffusion event signal decreases as a propagation distance increases.

The initial energy value represents an initial value of the virtual energy of the diffusion event signal, and the termination threshold represents an energy threshold that is of the virtual energy and that is at a time when the diffusion event signal stops propagating. For example, the propagation distance is a distance by which the diffusion event signal is propagated from the first zone server to another zone server or a message transit node. The diffusion event signal is propagated along the topology propagation path, and the propagation distance may be determined according to the topology propagation path.

According to an aspect, for an event signal whose type ID is indicated as a diffusion event (that is, a diffusion event signal), the first zone server may configure an initial energy value and a termination threshold of the diffusion event signal. The initial energy value and the termination threshold both belong to the preset propagation parameter of the diffusion event signal. The preset propagation parameter indicates a propagation mode of the event signal of the diffusion event. For the diffusion event signal, because a propagation direction is automatically configured as non-directional propagation, only an initial energy value and a termination threshold in non-directional propagation need to be configured. The initial energy value and the termination threshold are used to determine a propagation mode of the diffusion event signal (the initial energy value is used to determine original virtual energy (that is, an initial value of the virtual energy), and the termination threshold is used to determine a case in which propagation is stopped).

According to an aspect, different preset propagation parameters are configured for diffusion event signals with different event IDs. That is, even if signals are all diffusion event signals (e.g., the events are diffusion events), when event IDs are different, the signals may have different initial energy values and/or termination thresholds. In this way, the preset propagation parameters of the diffusion event signals can be more diversified, and human-computer interaction efficiency can be improved. In this case, an event ID may have a preset propagation parameter, allowing for quick determining of an initial energy value and a termination threshold of the diffusion event signal based on the event ID. Preset propagation parameters may improve efficiency of accessing the preset propagation parameter and calculation efficiency of the cloud game. For example, each zone server buffers a preset propagation parameter routing table of a diffusion event signal. In the preset propagation parameter routing table, a key-value data structure is used to indicate a preset propagation parameter that is configured for each diffusion event signal. For example, an event ID of each diffusion event signal is used as a key, and a 2-tuple {initial energy value, termination threshold} of each diffusion event signal is used as a value. In this way, after an event ID is determined, the event ID can be used as an index to rapidly query the preset propagation parameter routing table to find a corresponding 2-tuple {initial energy value, termination threshold}, thereby rapidly configuring an initial energy value and a termination threshold for a current diffusion event signal and improving configuration efficiency of the preset propagation parameter.

According to another aspect, the initial energy value and/or the termination threshold may be values calculated in real time according to an attribute of a virtual object controlled by a user. In this way, even if event IDs are the same, if attributes of virtual objects of triggering events are different, initial energy values and/or termination thresholds may be different, thereby greatly diversifying transmission parameter values of the diffusion event signal. Formulas for calculating the initial energy value and/or the termination threshold based on an attribute and a preset propagation parameter may be predefined. Formulas may also differ according to sects, equipment, attributes, skills, and the like of virtual objects. This is not specifically limited herein.

According to aspects described herein, when the first zone server does not configure the initial energy value and the termination threshold of the diffusion event signal, the initial energy value and the termination threshold of the diffusion event signal may be automatically set to default values. For example, the default initial energy value is unit 1, and the default termination threshold is 1/10. In this case, when the diffusion event signal starts to be propagated in the first zone server, virtual energy is unit 1, and if the virtual energy attenuates to be less than 1/10 in propagation in the virtual world, the propagation is stopped. Other default initial energy values and termination thresholds may be configured. The initial energy value and the termination threshold are not necessarily proportional, and may be separately configured as absolute values. For example, the initial energy value is 10, and the termination threshold is 1. This is not specifically limited herein.

In the foregoing operations 501 and 502, a method for configuring, based on the type of the event signal, the preset propagation parameter is depicted. When the type of the event signal is a diffusion event signal, the preset propagation parameter of the diffusion event signal includes at least an initial energy value and a termination threshold. When virtual energy of the diffusion event signal in a propagation process is less than the termination threshold, the diffusion event signal stops being propagated, so as to ensure that the diffusion event signal is not continuously transmitted in a virtual world without stopping. This reduces transmission overheads of the diffusion event signal and ensuring high controllability of the transmission overheads of the diffusion event signal.

503: Determine at least one path waypoint and at least one path end point of the diffusion event signal by using the first zone server as a path start point, wherein a value obtained after attenuation of the initial energy value when the diffusion event signal reaches the at least one path end point is less than the termination threshold.

The topology propagation path uses the first zone server as a path start point and uses the second zone server as a path end point. For any event signal, there is only one path start point of the topology propagation path, but there may be one or more path end points. Usually, there are at least two path end points of the diffusion event signal, and there is only one path end point of the one-way transmission event signal.

For the diffusion event signal, the second zone server is not specified by the first zone server, and the second zone server is determined from the service zone server set based on the preset propagation parameter. Besides, the diffusion event signal is similar to spreading to a surrounding logically connected node by using the first zone server as a path start point, and stops spreading when virtual energy is insufficient (less than a termination threshold). Therefore, there are usually a plurality of branches on a topology propagation path of the diffusion event signal, each branch has a path end point, the path end point of each branch indicates a second zone server, and all nodes on each branch other than the path start point and the path end point are path waypoints. The path waypoint may be a zone server or a message transit node, a plurality of branches may have the same path end point (however, because path waypoints are different, the different branches are obtained through division), and each branch is a message transmission path from a path start point to a path end point. According to an aspect, the plurality of branches may include a branch that includes only a path start point and a path end point and does not include a path waypoint.

According to an aspect, after the initial energy value and the termination threshold of the diffusion event signal are configured in the first zone server (e.g., a source node), the diffusion event signal is propagated in all connection directions in the first zone server. For each path waypoint other than the first zone server, the diffusion event signal is propagated in all connection directions other than a source direction on the path waypoint. The source direction is a source direction from which the path waypoint receives the diffusion event signal. In addition, the diffusion event signal conforms to an equal energy division principle during each propagation. Additionally or alternatively, virtual energy of the same diffusion event signal from different branches may be superposed in the same path waypoint, and energy values are added and then the virtual energy is diffused to the outside. Moreover, when the path end point is reached, propagation is stopped because virtual energy is less than a termination threshold. When the virtual energy is less than the termination threshold, propagation is stopped and a path end point is found; otherwise, the virtual energy continues to be propagated from a path waypoint to another connected node.

The following uses an example of a diffusion event signal that stops after being propagated for N times, where N is an integer greater than or equal to 1. A manner of determining at least one path waypoint and at least one path end point on a topology propagation path of the diffusion event signal is described in detail by using operations 5031 to 5033.

5031: Determine, by using the first zone server as a path start point, a plurality of first-order propagation directions of the diffusion event signal, and a first-order energy value obtained after attenuation of the initial energy value after the diffusion event signal is propagated for the first time.

According to an aspect, in a topology space of a virtual world, the first zone server is used as a path start point, and all connection directions of the first zone server are determined as a plurality of first-order propagation directions of the diffusion event signal. Next, according to an equal energy division principle, virtual energy of the diffusion event signal is equally divided according to a quantity of the first-order propagation directions. A first-order energy value is obtained after attenuation after the diffusion event signal is propagated once in each first-order propagation direction.

In an example, FIG. 6 is a diagram of a propagation topology of a diffusion event signal according to aspects described herein. FIG. 6 shows an extended topology structure of a partial plane of a sphere in a topology space of a virtual world. Each triangle is used to represent a node, and the node may be a zone server or a message transit node. Node 61 represents a first zone server of a current diffusion event signal. The node 61 is used as a path start point, wherein all three connection directions “↑”, “ [symbol] ”, and “ [symbol] ” of the node 61 are found, and the three connection directions are used as three first-order propagation directions of the diffusion event signal, wherein the first-order propagation directions respectively lead to nodes 62, 63, and 64 (e.g., three path waypoints). Meanwhile, according to an equal energy division principle, an initial energy value of the diffusion event signal is equally divided into three equal parts, to obtain three first-order energy values of the diffusion event signal in the three first-order propagation directions. For example, assuming that the initial energy value of the diffusion event signal is a unit 1, the three first-order energy values of the diffusion event signal in the three first-order propagation directions are all ⅓.

5032: Determine, based on a path waypoint in each first-order propagation direction if the first-order energy value is not less than the termination threshold, a plurality of second-order propagation directions of the diffusion event signal, and a second-order energy value obtained after attenuation of the initial energy value after the diffusion event signal is propagated for the second time.

According to an aspect, if a first-order energy value of the diffusion event signal in each first-order propagation direction is less than a termination threshold, propagation is stopped, and a path waypoint to which the diffusion event signal leads in each first-order propagation direction is used as a path end point. If the first-order energy value of the diffusion event signal in each first-order propagation direction is not less than the termination threshold, the diffusion event signal may continue to be propagated outward. Therefore, after the path waypoint to which the diffusion event signal leads in each first-order propagation direction is found, with reference to the manner similar to operation 5031, in the topology space of the virtual world, all connection directions other than a source direction on the path waypoint are determined as a plurality of second-order propagation directions of the diffusion event signal. The source direction is a source direction in which the path waypoint receives the diffusion event signal. Next, according to an equal energy division principle, the first-order energy value of the diffusion event signal on the path waypoint is equally divided according to a quantity of second-order propagation directions, obtaining a second-order energy value after attenuation and after the diffusion event signal is propagated for the second time in each second-order propagation direction.

For example, as seen in FIG. 6, after the diffusion event signal is propagated for the first time from the node 61, virtual energy is divided into three parts, and reaches three path waypoints. The three path waypoints are respectively nodes 62, 63, and 64. The three path waypoints in the topology space may all be message transit nodes (not representing a zone server and not participating in a service logic operation). Additionally or alternatively, the three path waypoints may be either a zone server or a message transit node. In a process of propagation for the second time, the node 62 is used as an example for description. In addition to the source direction “ [symbol] ”, the node 62 also has two connection directions “ [symbol] ” and “↓”. Therefore, all the remaining two connection directions other than the source direction are used as two second-order propagation directions of the diffusion event signal, and the two second-order propagation directions respectively lead to nodes 65 and 66 (e.g., two path waypoints). In addition, according to an equal energy division principle, the first-order energy value of the diffusion event signal is equally divided into two equal parts, to obtain two second-order energy values of the diffusion event signal in the 2 second-order propagation directions. For example, assuming that the first-order energy value of the diffusion event signal is ⅓, the two second-order energy values of the diffusion event signal in the 2 second-order propagation directions are both ⅙. A second-order propagation process of the nodes 63 and 64 may be similar to that of the node 62. For example, the second-order propagation process is a process of propagation for the second time in the second-order propagation direction.

5033: Repeat the foregoing operations, until an N^{th}-order energy value obtained after attenuation of the initial energy value, based on the diffusion event signal being propagated for the N^{th} time, is less than the termination threshold, and determine a path waypoint in each N^{th}-order propagation direction as a path end point.

According to an aspect, if a second-order energy value of the diffusion event signal in each second-order propagation direction is less than a termination threshold, propagation is stopped, and a path waypoint to which the diffusion event signal leads in each second-order propagation direction is used as a path end point. If the second-order energy value of the diffusion event signal in each second-order propagation direction is not less than the termination threshold, the diffusion event signal may continue to be propagated outward. Therefore, after the path waypoint to which the diffusion event signal leads in each second-order propagation direction is found, third-order propagation directions may be determined similarly to operation 5032. The source direction is a direction from which the path waypoint receives the diffusion event signal. Again, according to an equal energy division principle, the second-order energy value of the diffusion event signal on the path waypoint is equally divided according to a quantity of third-order propagation directions, to obtain a third-order energy value after attenuation and after the diffusion event signal is propagated for the third time in each third-order propagation direction. The process may continue until an N^{th}-order energy value calculated for the diffusion event signal is less than the termination threshold. At this point, propagation be stopped, and a path waypoint in the N^{th}-order propagation direction is set as a path end point. The path waypoint may be a zone server or a message transit node, and the path end point may also be a zone server or a message transit node.

For example, FIG. 6 depicts the following propagation process. In a case in which the termination threshold is 1/10, in a process of propagation for the third time, a second-order energy value of the path waypoint 65 is 1/6. In this case, in addition to a source direction “ [symbol] ”, 2 third-order propagation directions “↑” and “ [symbol] ” are further found. The two third-order propagation directions respectively lead to nodes 67 and 68. In addition, according to an equal energy division principle, the second-order energy value of the diffusion event signal is equally divided into two equal parts, to obtain two third-order energy values of the diffusion event signal in the two third-order propagation directions. For example, assuming that the second-order energy value of the diffusion event signal is ⅙, the two third-order energy values of the diffusion event signal in the two third-order propagation directions are both 1/12. In this case, for the node 67, because the third-order energy value is 1/12 of the diffusion event signal, the third-order energy value is less than the termination threshold 1/10. The diffusion event signal stays in the node 67 and is not further propagated from the node 67. In this case, if the node 67 is a zone server, the node 67 serves as a second zone server of the diffusion event signal and the diffusion event signal participates in a service logic operation of the second zone server. If the node 67 is not a zone server, and instead is a message transit node, the diffusion event signal does not participate in the service logic operation, and the message transit node may discard the diffusion event signal after buffering for a period of time, or may directly discard the diffusion event signal without buffering.

According to operations 5031 to 5033, a possible implementation of how to determine a path waypoint and a path end point on a topology propagation path of a diffusion event signal is provided. In this manner of determining a path waypoint and a path end point on a topology propagation path, the first zone server may perform calculation. Alternatively, the first zone server performs calculations only for the first-order propagation direction of the first zone server and performs transmission to a path waypoint in the first-order propagation direction of the first zone server, and each path waypoint performs calculation only for a next-order propagation direction of the path waypoint and performs transmission to a path waypoint in the next-order propagation direction of the path waypoint (if virtual energy is less than the termination threshold, propagation is stopped). This prevents the first zone server from calculating all topology propagation paths, thereby reducing calculation overheads of the first zone server.

For example, determining the at least one path waypoint and the at least one path end point on the topology propagation path of the diffusion event signal by using the first zone server as a path start point is implemented by using the following operation 503a to operation 503c:

503a: Determine, by using the first zone server as a path start point, a first-order propagation direction of the diffusion event signal, a path waypoint of the diffusion event signal in the first-order propagation direction, and a first-order energy value obtained after attenuation of the initial energy value after the diffusion event signal is propagated for the first time in the first-order propagation direction.

503b: Determine, based on the path waypoint in the first-order propagation direction if the first-order energy value is not less than the termination threshold, a second-order propagation direction of the diffusion event signal, a path waypoint of the diffusion event signal in the second-order propagation direction, and a second-order energy value obtained after attenuation of the initial energy value after the diffusion event signal is propagated for the second time in the second-order propagation direction.

503c: Set the path waypoint in the second-order propagation direction as the path end point if the second-order energy value is less than the termination threshold.

The third-order propagation direction of the diffusion event signal, the path waypoint of the diffusion event signal in the third-order propagation direction, and the third-order energy value obtained after attenuation of the initial energy value after the diffusion event signal is propagated for the third time in the third-order propagation direction are determined based on the path waypoint in the second-order propagation direction if the second-order energy value is not less than the termination threshold. This process is repeated until the latest determined energy value is less than the termination threshold, and a path end point corresponding to the latest determined energy value is determined as the path end point.

In operations 503a to 503c, there is one propagation direction for each order, and corresponding, there is one energy value for each order. Additionally or alternatively, for a diffusion event signal, there may be a plurality of propagation directions of each order, and a corresponding plurality of energy values of each order. An example in which there are a plurality of n^{th}-order energy values is used for further description, where n is an integer not less than 1. If there is a plurality of n^{th}-order energy values, after the plurality of n^{th}-order energy values are determined, whether each n^{th}-order energy value is less than the termination threshold needs to be determined. If any n^{th}-order energy value is not less than the termination threshold, based on a path waypoint in any n^{th}-order propagation direction corresponding to the any n^{th}-order energy value, an (n+1)^{th}-order propagation direction of the diffusion event signal, a path waypoint of the diffusion event signal in the (n+1)^{th}-order propagation direction, and an (n+1)^{th}-order energy value obtained after attenuation of the initial energy value after the diffusion event signal is propagated for the (n+1)^{th} time in the (n+1)^{th}-order propagation direction are determined. Then, the (n+1)^{th}-order energy value is processed according to processing logic that is the same as that of the n^{th}-order energy value. A path waypoint in any n^{th}-order propagation direction corresponding to any n^{th}-order energy value is set as the path end point if the any n^{th}-order energy value is less than the termination threshold.

504: Determine the topology propagation path of the diffusion event signal in the service zone server set based on the path start point, the at least one path waypoint, and the at least one path end point.

Because the path end point is determined by sequentially determining path waypoints from the path start point, the path waypoints between the path start point and the path end point can be determined. A path formed by a path start point, a path waypoint between the path start point and any path end point, and the any path end point is used as a branch of the topology propagation path, and after all path end points are traversed, a path formed by all determined branches is used as the topology propagation path of the diffusion event signal in the service zone server set.

In the foregoing process, the diffusion event signal is used as an example, to describe how to determine the topology propagation path of the diffusion event signal in the service zone server set based on the preset propagation parameter of the diffusion event signal. Specifically, the preset propagation parameter of the diffusion event signal includes an initial energy value and a termination threshold, and the propagation direction of the diffusion event signal has a feature of being non-directional. In this way, an energy value obtained after attenuation after the diffusion event signal is propagated each time can be determined, and the energy value obtained after attenuation is compared with the termination threshold, to determine whether a current node is a path waypoint or a path end point. Then, a path start point, all path waypoints, and all path end points jointly form a topology propagation path of the diffusion event signal, a connection edge between different nodes in the topology propagation path is a directed edge, and a direction of the directed edge represents a propagation direction of a specific order of the diffusion event signal.

505: Transmit, along the topology propagation path, the diffusion event signal from the first zone server to the at least one second zone server indicated by the at least one path end point.

The diffusion event signal participates in a service logic operation of the second zone server after reaching the second zone server.

According to an aspect, after the topology propagation path of the diffusion event signal is determined in operations 503 and 504, the event signal of the diffusion event may be broadcast from the first zone server to a path waypoint in each first-order propagation direction, the path waypoint in the first-order propagation direction continues to broadcast the event signal of the diffusion event to a path waypoint in each second-order propagation direction, and so on, until it is found that an N^{th}-order energy value is less than a termination threshold when the event signal is broadcast to a path waypoint in an N^{th}-order propagation direction. In this case, the path waypoint in the N^{th}-order propagation direction stops propagating the diffusion event signal, and the path waypoint in the N^{th}-order propagation direction is a path end point on the topology propagation path.

Because there are a plurality of branches on the topology propagation path of the diffusion event signal and each branch has a path end point, there may be one or more path end points. The path end point may be a zone server or may be a message transit node. When a path end point is a zone server, the path end point may be used as a second zone server of the diffusion event signal, and the event signal of the diffusion event participates in a service logic operation of the second zone server after reaching the second zone server. Therefore, there may be one or more second zone servers of the diffusion event signal, and the diffusion event signal participates in a service logic operation of each second zone server. In addition, in a transmission process of the diffusion event signal, because the path waypoint may be a zone server or may be a message transit node, each time the diffusion event signal reaches a path waypoint representing a zone server, the diffusion event signal also participates in a service logic operation of the zone server represented by the path waypoint, to ensure that the diffusion event signal spreads to each zone server through which the diffusion event signal passes. Returning to FIG. 6, the diffusion event signal participates in a service logic operation of each node representing a zone server in the topology propagation path. For example, when the diffusion event signal is a reward event, each node representing a zone server in the topology propagation path receives and publishes the reward event, thereby implementing “cross-zone-server reward”. For example, on a branch “node 61→node 62→node 65→node 67”, the node 61 is a first zone server, the node 67 is a second zone server, and the node 62 and the node 65 are both message transit nodes. In this case, both the first zone server and the second zone server publish the reward event. In the foregoing process, cross-zone-server interaction efficiency of a user is greatly improved. In addition, not only a reward event can be transmitted across zone servers, but also a rewarded player may traverse across zone servers by using a one-way transmission event. In this way, a cross-zone-server interaction manner of a cloud game is greatly improved, and human-computer interaction efficiency is greatly improved.

According to an aspect, according to an equal energy division principle, each time the diffusion event signal is propagated, virtual energy of the diffusion event signal is equally divided based on a quantity of propagation directions of current propagation. For example, if a quantity of N^{th}-order propagation directions during propagation of the N^{th} time is m, an (N−1)^{th}-order energy value e of the diffusion event signal is equally divided into m equal parts. In this way, an N^{th}-order energy value after attenuation in each N^{th}-order propagation direction is calculated as e/m.

Additionally or alternatively, the diffusion event signal may not conform to the equal energy division principle on each branch of the topology propagation path. For example, N^{th}-order energy values obtained after attenuation in different propagation directions are configured according to channel quality of communication connections in N^{th}-order propagation directions, such that a communication connection with better channel quality has a higher energy value and ensuring message transmission for communication connections with better channel quality. In another example, N^{th}-order energy values obtained after attenuation in different propagation directions are configured according to channel lengths of communication connections in N^{th}-order propagation directions such that a communication connection with a shorter channel length has a higher energy value, so as to accelerate propagation speed of the diffusion event signal. Other configurations may also be possible.

Different path waypoints may have different processing periods. For the zone server, the processing period is a calculation period, and for the message transit node, the processing period is a receiving and sending period. In other words, different nodes have different processing speeds for the event signal. Therefore, even if quantities of propagations are equal, the event signal of the diffusion event does not necessarily reach corresponding path waypoints (or path end points) at the same time. A diffusion event signal may reach path waypoints in propagation directions of a specific order at a same time or differing times.

According to an aspect, virtual energy of the diffusion event signal is combined according to durations of times of reception if a path waypoint on the topology propagation path receives the same diffusion event signal a plurality of times. In this way, in a process of transmitting the diffusion event signal, if the same path waypoint receives the same diffusion event signal from different nodes in a plurality of propagation directions, similar to a principle of superposition and interference of light waves, the path waypoint combines virtual energy of the diffusion event signal received from the plurality of propagation directions. After combination, energy of the diffusion event signal is enhanced, further supporting continuous transmission, and thereby helping to lengthen a propagation length of the diffusion event signal and improving a propagation coverage of the diffusion event signal. For example, in FIG. 6, the node 68 receives an event signal of a diffusion event A from the node 69 in the “ [symbol] ” direction, and also receives an event signal of the diffusion event A from the node 65 in the “↑” direction. Therefore, the node 68 receives the event signal of the diffusion event A twice from two different source directions. In this way, virtual energy of the event signal of the diffusion event A can be combined. In FIG. 6, an original third-order energy value of the event signal of the diffusion event A from each source direction is 1/12. However, after combination, the virtual energy of the event signal of the diffusion event A changes to ⅙, and is no longer less than the termination threshold 1/10. In this way, the node 68 can still continue to propagate the event signal of the diffusion event A. The event signal of the diffusion event A uses the node 68 as a path waypoint instead of a path end point. That is, the node 68 sends the event signal of the diffusion event A to the node 610 in the remaining propagation direction “ [symbol] ”, and configures a fourth-order energy value as ⅙. Similarly, the node 610 sends the event signal of the diffusion event A to the node 611 and the node 612 again, and configures a fifth-order energy value as 1/12. Because 1/12 is less than the termination threshold 1/10, the node 611 and the node 612 are final path end points, and stop propagation.

Additionally or alternatively, the path waypoint may not combine the virtual energy of the diffusion event signal according to a quantity of receiving times. In this way, once an event signal with a virtual energy less than a termination threshold is received at a node, the event signal may be discarded and does not need to be buffered. Then, the node can wait for arrivals of future event signals of another node, and whether the event signal is an event signal of the same diffusion event is determined. In this way, storage overheads of each node can be reduced, and event processing efficiency of each node can be accelerated.

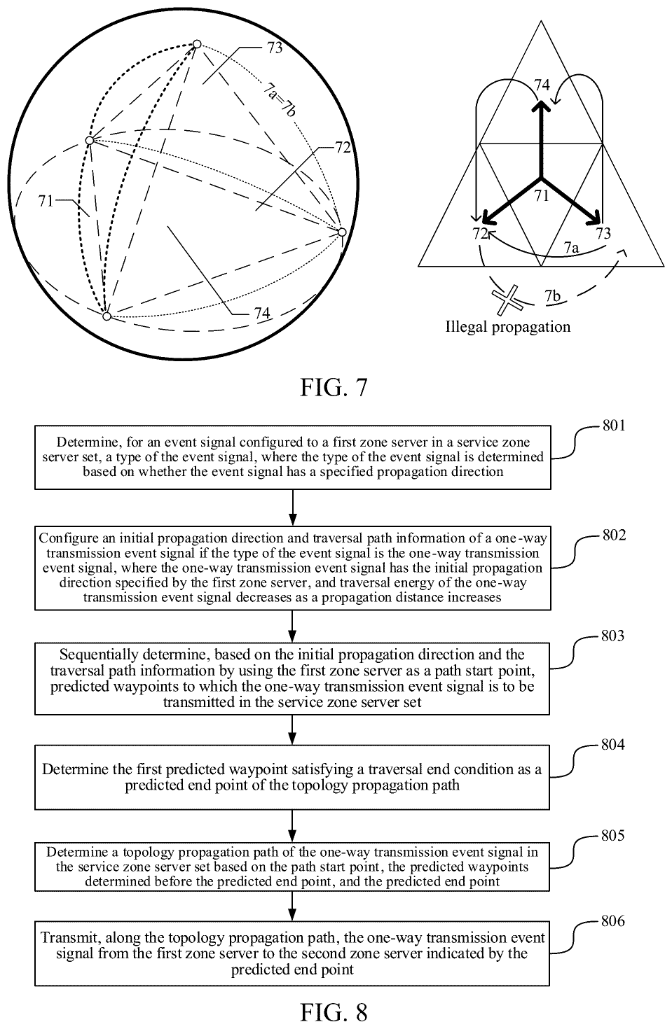

One communication connection allows an event signal of the same diffusion event to pass through only once, and if the event signal does not find a legal propagation direction on a path waypoint, propagation is stopped. For example, FIG. 7 is a diagram of a message transmission mechanism of a diffusion event signal according to aspects described herein. As shown in FIG. 7, when a virtual world is initialized, the virtual world has only 4 nodes, and the 4 nodes include 1 zone server 71 and three message transit nodes 72, 73, and 74. In this case, the zone server 71 sends an event signal of a diffusion event, and virtual energy of the diffusion event signal is equally divided into three parts and transmitted to the three surrounding message transit nodes 72, 73, and 74. It can be seen that because edge 7a and edge 7b are actually the same large arc on a spherical surface, the event signal of the diffusion event is not propagated on the edge 7b (a propagation direction is illegal). Because the three message transit nodes 72, 73, and 74 have no other communication connections that can be used to transmit the event signal, the diffusion event signal stops propagating.

All the foregoing optional technical solutions may be combined according to aspects described herein, and details are not described herein. According to aspects described herein, a message transmission mechanism across zone servers using an event signal as a carrier is constructed between zone servers of the virtual world, and a non-directional propagation direction is customized for a diffusion event signal. The first zone server only needs to configure an initial energy value and a termination threshold, so that the diffusion event signal can be spontaneously broadcast to all connection directions, and stop broadcast when virtual energy is less than the termination threshold. This can ensure that the diffusion event signal can be transmitted across different zone servers along the topology propagation path. In addition, this can ensure that the diffusion event signal is not transmitted in the virtual world without stopping, so that cross-zone-server interaction can be implemented for the diffusion event signal within the virtual world, thereby greatly improving transmission efficiency of a message transmitted by using the diffusion event signal as a carrier.

According to further aspects described herein, another one-way transmission event signal other than the diffusion event signal is used as an example, and a transmission mechanism of a one-way transmission event signal between different zone servers in the service zone server set is described. FIG. 8 is a flowchart of an event signal transmission method according to aspects described herein. Referring to FIG. 8, the service zone server set includes at least two zone servers, wherein each zone server in the service zone server set is uniquely associated with one virtual sub-world in a virtual world, the at least two zone servers include a first zone server and a second zone server that are logically connected, the first zone server is a source node of an event signal, and the second zone server is a destination node of the event signal. A transmission method for the one-way transmission event signal includes the following operation 801 to operation 806:

801: Determine, for an event signal configured to a first zone server in a service zone server set, a type of the event signal, where the type of the event signal is determined based on whether the event signal has a specified propagation direction.

Operation 801 is the same as operation 501. Details are not described herein again.

In the following example, the type of the event signal is a one-way transmission event signal. When encapsulating a one-way transmission event into an event signal, the first zone server describes the one-way transmission event by using an event description vector [what, which, where, when]. What in the event description vector records an event ID, an event type, and a preset propagation parameter. The event ID is used for uniquely identifying an event (which is determined based on action indication information triggered by a user on the game client), the event type is used for indicating whether the event identified by the event ID is a diffusion event or a one-way transmission event, and the preset propagation parameter is used for indicating at least one of a propagation direction or a propagation mode of an event signal carrying the event. For the one-way transmission event signal, the preset propagation parameter of the one-way transmission event signal includes at least an initial propagation direction and traversal path information determined in the following operation 802.

802: Configure an initial propagation direction and traversal path information of a one-way transmission event signal if the type of the event signal is the one-way transmission event signal, where the one-way transmission event signal has the initial propagation direction specified by the first zone server, and traversal energy of the one-way transmission event signal decreases as a propagation distance increases.

The traversal path information represents a change rule of a propagation direction in propagation of the one-way transmission event signal. For example, the propagation distance is a distance by which the one-way transmission event signal is propagated from the first zone server to another zone server or a message transit node. The one-way transmission event signal is propagated along the topology propagation path, and the propagation distance may be determined according to the topology propagation path.

According to an aspect, for an event signal whose type ID indicates a one-way transmission event (that is, a one-way transmission event signal), the first zone server may configure an initial propagation direction and traversal path information of the one-way transmission event signal. The initial propagation direction and the traversal path information both belong to a preset propagation parameter of the one-way transmission event signal. The preset propagation parameter indicates a propagation direction and a propagation mode of the one-way transmission event signal. For the one-way transmission event signal, because the propagation direction is directional propagation, the first zone server needs to configure at least an initial propagation direction of the one-way transmission event signal in the first zone server. Subsequently, a propagation direction on each predicted waypoint may be randomly selected, or indicated by the traversal path information. In addition, because whether transmission of the one-way transmission event signal is stopped is determined according to a traversal termination condition, a termination threshold does not need to be configured for the one-way transmission event signal.

To distinguish from the virtual energy of the diffusion event, the virtual energy of the one-way transmission event signal is referred to as traversal energy. Therefore, an initial energy value of the traversal energy may be configured as a default value, or may be calculated through conversion according to an attribute of a virtual object triggering the one-way transmission event signal. Other methods of configuring the initial energy value of the traversal energy may be possible.

For the one-way transmission event signal, a propagation mode of the one-way transmission event signal depends on the initial propagation direction and the traversal path information (a direction of transmission from the first zone server depends on the initial propagation direction, and the traversal path information indicates a change rule of the propagation direction each time a predicted waypoint is reached). In this way, a topology propagation path can be uniquely determined in the virtual world, and this topology propagation path has only one unique branch. The unique branch uses the first zone server as a path start point, and a predicted end point may be predicted by using the following operations 803 and 804. However, this predicted end point is not necessarily a path end point on which transmission finally stops. This is because a traversal termination condition may probably be satisfied in advance on a predicted waypoint in a propagation process of the one-way transmission event signal. Therefore, the one-way transmission event signal is not actually transmitted to an initial predicted end point. This is because after the one-way transmission event signal starts to be propagated, although a possible traversal path can be preset, a final traversal result in the future cannot be predicted. Even if a second zone server is specified, the traversal may not be successful. Therefore, to distinguish from a path waypoint and a path end point of a diffusion event, only a predicted waypoint and a predicted end point are used for the one-way transmission event signal. Only when it is observed at a future time that the one-way transmission event signal successfully reaches a predicted waypoint, this predicted waypoint becomes an actual path waypoint. Only when it is observed at a future time that the one-way transmission event signal successfully reaches a specified second zone server, a predicted end point corresponding to this second zone server becomes an actual path end point.

According to an aspect, the initial propagation direction and the traversal path information are both specified by a user, or the initial propagation direction is specified by a user, but the user does not need to specify the traversal path information, and instead specifies the second zone server. In this way, the system generates traversal path information according to the initial propagation direction and the second zone server. Other manners of configuring the initial propagation direction and the traversal path information may be possible. Additionally or alternatively, when configuring a preset propagation parameter of a one-way transmission event signal, only an initial propagation direction may be configured, and subsequently, a propagation direction on each predicted waypoint is randomly selected. In this case, the preset propagation parameter is used for indicating the propagation direction of the one-way transmission event signal.

According to another aspect, the initial propagation direction and the traversal path information may be defaulted. If the first zone server does not specify the initial propagation direction, according to the relativity principle, there is no absolute direction in the spherical topology space, and all directions are equal. Therefore, a determined initial propagation direction may be randomly selected from all connection directions of the first zone server. Similarly, if the first zone server does not specify the traversal path information, whether the first zone server specifies a second zone server is determined. If the first zone server specifies the second zone server, a piece of traversal path information is formed by using the first zone server as a path start point and the second zone server as a predicted end point. If the first zone server does not specify the second zone server, the first zone server may randomly initialize to obtain a piece of traversal path information, or a predicted waypoint randomly selects a next-order propagation direction each time the predicted waypoint is reached.

According to an aspect, a possible implementation of the traversal path information is provided, that is, the traversal path information includes traversal indication information respectively corresponding to a plurality of propagations, and traversal indication information corresponding to any one of the propagations indicates whether a propagation direction of the one-way transmission event signal in the any one of the propagations is rotating clockwise or counterclockwise. In other words, the traversal indication information corresponding to any one of the propagations indicates a change rule of a propagation direction of the one-way transmission event signal in the any one of the propagations, and the change rule is rotating clockwise relative to a propagation direction of the one-way transmission event signal in previous propagation, or rotating anticlockwise relative to a propagation direction of the one-way transmission event signal in previous propagation. In this way, by controlling the quantity of pieces of traversal indication information included in the traversal path information, the propagation distance and the quantity of propagations of the one-way transmission event signal can be controlled. By controlling a value of each piece of traversal indication information, a change rule of a propagation direction of the one-way transmission event signal during each propagation relative to a previous propagation direction can be controlled, so as to control both the propagation direction and the propagation mode of the one-way transmission event signal, thereby implementing high controllability of the propagation direction and the propagation mode of the one-way transmission event signal. An angle for clockwise rotation and an angle for anticlockwise rotation may be set according to experience, or may be explicitly indicated in the traversal path information.

For example, the traversal path information is implemented as a traversal indication vector. Each value in the traversal indication vector is one piece of traversal indication information. The traversal indication information is implemented as one piece of integer data. When a value of the integer data is −1, it indicates that the first propagation direction obtained by rotating clockwise relative to a previous propagation direction is selected as a current propagation direction. When a value of the integer data is 1, it indicates that the first propagation direction obtained by rotating anticlockwise relative to the previous propagation direction is selected as a current propagation direction. For example, when the traversal indication vector is [−1, −1, 1, 1, −1, −1, 1], it indicates that the first propagation direction obtained by rotating the initial propagation direction clockwise is selected as a first-order propagation direction, the first propagation direction obtained by rotating the first-order propagation direction clockwise is selected as a second-order propagation direction, the first propagation direction obtained by rotating the second-order propagation direction anticlockwise is selected as a third-order propagation direction, and so on. Details are not described again.

According to an aspect, in addition to integer data, the traversal indication information may also be implemented as binary data or Boolean data. A value of the binary data is 1 or 0, and a value of the Boolean data is true or false. This exactly corresponds to a change rule of two propagation directions (clockwise/anticlockwise).

According to an aspect, a one-way transmission event may be provided as a cross-zone-server traversal event of a virtual object in the service zone server set, or a one-way transmission event may be provided as a cross-zone-server traversal event that is of a virtual prop fired by a virtual object and that is in the service zone server set. Specific content of the one-way transmission event is not limiting. In this way, cross-zone-server traversal of the virtual object itself can be controlled, and cross-zone-server traversal of the virtual prop itself can also be controlled by using a one-way transmission event, so that players in a virtual world are more diversified. In addition, the virtual object and the virtual prop can both be transmitted between different zone servers in a form of one-way transmission event signal. In terms of rendering, the virtual object and the virtual prop are both virtual elements, the virtual element is rendered to a game picture of a zone server that is passed through, and the virtual element is transmitted across zone servers in a form of one-way transmission event signal. This means that a virtual object or a virtual prop represented by a virtual element may appear/disappear in game pictures of virtual sub-worlds of different zone servers, thereby greatly improving human-computer interaction efficiency and diversity of playing methods.

For example, when the one-way transmission event is a cross-zone-server traversal event of a virtual object in the service zone server set, the one-way transmission event signal is a signal of the cross-zone-server traversal event of the virtual object in the service zone server set. When the one-way transmission event is a cross-zone-server traversal event that is of a virtual prop fired by a virtual object and that is in the service zone server set, the one-way transmission event signal is a signal of the cross-zone-server traversal event that is of the virtual prop fired by the virtual object and that is in the service zone server set.

In the foregoing operations 801 and 802, a possible implementation of configuring, based on the type of the event signal, the preset propagation parameter matching the type of the event signal is provided. When the type of the event signal is a one-way transmission event signal, the preset propagation parameter of the one-way transmission event signal may include at least the initial propagation direction and the traversal path information of the one-way transmission event signal. In this way, a topology propagation path having a unique branch can be determined in a virtual world by using the initial propagation direction and the traversal path information, which ensures that a virtual element associated with the one-way transmission event signal does not appear in game pictures of two zone servers at the same time without special definition, and also improves controllability of the one-way transmission event signal.

803: Sequentially determine, based on the initial propagation direction and the traversal path information by using the first zone server as a path start point, predicted waypoints to which the one-way transmission event signal is to be transmitted in the service zone server set.

A predicted waypoint that the one-way transmission event signal has reached constitutes the topology propagation path at a current time. The topology propagation path uses the first zone server as a path start point and the second zone server as a predicted end point. For a one-way transmission event signal, there is only one path start point and one predicted end point of the topology propagation path. However, unpredictability exists at a future time, each zone server has no information beyond the zone server at a current time, and information is permanently limited by a transmission speed. As a result, the predicted end point is not necessarily a path end point at which propagation of the one-way transmission event signal finally stops, that is, whether the one-way transmission event signal can finally reach the predicted end point is unknown. According to an aspect, the second zone server is selected according to a traversal termination condition specified by the first zone server. Therefore, the topology propagation path of the one-way transmission event signal has a unique branch, and a predicted end point on the unique branch is the second zone server. There may be one or more predicted waypoints on the unique branch. The predicted waypoint may be a zone server, or may be a message transit node. The topology propagation path of the one-way transmission event signal is equivalent to a uniquely determined message transmission path from the first zone server to the second zone server.

A one-way transmission event signal is used as an example below, and a manner of determining each predicted waypoint on a topology propagation path of the one-way transmission event signal is described in detail by using operations 8031 to 8032.

8031: Determine the first predicted waypoint of the one-way transmission event signal based on the initial propagation direction by using the first zone server as a path start point.

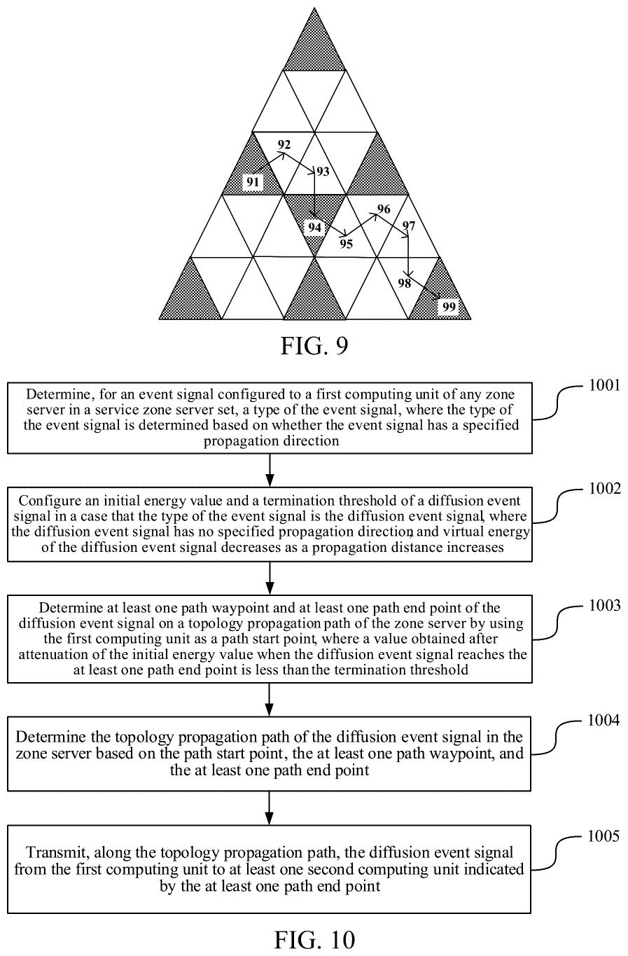

According to an aspect, in a topology space of a virtual world, the first zone server is used as a path start point, and a node connected to the first zone server in the initial propagation direction is used as the first predicted waypoint. In an example, FIG. 9 is a diagram of a propagation topology of a one-way transmission event signal according to aspects described herein. FIG. 9 shows an extended topology structure of a partial plane of a sphere in a topology space of a virtual world. Each triangle is used to represent a node. Because the node may be a zone server or a message transit node, to distinguish the zone server from the message transit node, a node represented by a triangle including a shadow is a zone server, and a node represented by a triangle not including a shadow is a message transit node. Assuming that a node 91 represents a first zone server of a current one-way transmission event signal, and an initial propagation direction specified by the first zone server is “ [symbol] ”, a node 92 connected to the node 91 along the initial propagation direction “ [symbol] ” is used as the first predicted waypoint.

8032: Sequentially determine, based on the first predicted waypoint and the traversal path information, predicted waypoints of the one-way transmission event signal that are after the first predicted waypoint.

According to an aspect, in the topology space of the virtual world, for each predicted waypoint, a current propagation direction of the one-way transmission event signal on the predicted waypoint can be determined according to a source direction of the one-way transmission event signal on the predicted waypoint and the traversal path information, and then a node connected to the predicted waypoint in the current propagation direction is used as a next predicted waypoint. In this manner, a second predicted waypoint may be determined based on the first predicted waypoint and the traversal path information. A third predicted waypoint is determined based on the second predicted waypoint and the traversal path information, and so on, until predicted waypoints of the one-way transmission event signal that are after the first predicted waypoint are obtained.

According to an aspect, when the traversal path information is provided as a traversal indication vector, for each predicted waypoint, after a next predicted waypoint adjacent to the predicted waypoint is determined according to the traversal indication vector, the first traversal indication information of the traversal indication vector may further be removed. In this way, each time a new predicted waypoint is reached, because the traversal indication vector has been updated, a next predicted waypoint can be calculated according to only the first traversal indication information of the updated traversal indication vector, without paying attention to traversal indication information of other locations. In addition, after calculation is completed, the currently used traversal indication information is removed from the traversal indication vector. In this way, the traversal indication vector is continuously shortened in a traversal process, and when the second zone server is successfully reached, all traversal indication information of the traversal indication vector is removed, so as to stop traversal in the second zone server.

FIG. 9 is a diagram of a propagation topology of a one-way transmission event signal according to aspects described herein. Traversal path information may be implemented as a traversal indication vector [−1, −1, 1, 1, −1, −1, 1]. It is assumed that a value “−1” of the traversal indication information represents clockwise rotation, and a value “1” of the traversal indication information represents anticlockwise rotation. After the first predicted waypoint, that is, a node 92, is found in the initial propagation direction “ [symbol] ” of a node 91, the source direction is “ [symbol] ” for the node 92, and the first traversal indication information associated with the first predicted waypoint in the traversal indication vector is the value “−1”. Therefore, rotation is performed clockwise along the source direction to find the first propagation direction “ [symbol] ” as a first-order propagation direction, and a second predicted waypoint, that is, a node 93, is found in the first-order propagation direction “ [symbol] ” of the node 92. Next, the traversal indication vector is updated, and the first traversal indication information “−1” of the traversal indication vector is removed, to obtain the updated traversal indication vector [−1, 1, 1, −1, −1, 1]. Similarly, the source direction is “ [symbol] ” for the node 93, and the second traversal indication information associated with the second predicted waypoint in the traversal indication vector is the value “−1”. Therefore, rotation is performed clockwise along the source direction to find the first propagation direction “↓” as a second-order propagation direction, and a third predicted waypoint, that is, a node 94, is found in the second-order propagation direction “↓” of the node 93. Next, the traversal indication vector is updated, and the first traversal indication information “−1” of the traversal indication vector is removed, to obtain the updated traversal indication vector [1, 1, −1, −1, 1]. The rest can be deduced by analogy. Because the traversal indication vector is a vector of a limited length, the last predicted waypoint, that is, a node 99, may be finally found, and when the node 99 is reached, all traversal indication information of the traversal indication vector is removed. Therefore, the traversal indication information becomes an empty queue.

804: Determine the first predicted waypoint satisfying a traversal termination condition as a predicted end point of the topology propagation path.

According to an aspect, the traversal termination condition is a condition specified by the first zone server to specify stopping propagating the one-way transmission event signal. After all path waypoints of the one-way transmission event are found according to the initial propagation direction and the traversal path information in operation 803, a predicted end point can be selected from all the path waypoints in operation 804.

Usually, the predicted end point is the last predicted waypoint found in operation 803 (ensuring that operation of the traversal indication vector can be completed). However, in some cases, according to different traversal termination conditions, the predicted end point is not necessarily the last predicted waypoint. For example, in a case in which a traversal termination condition includes a limit on traversal energy, if the one-way transmission event signal has insufficient traversal energy on a predicted waypoint, the predicted waypoint becomes the predicted end point, and there is no chance to traverse to the last predicted waypoint and then stop.

The following describes several possible traversal termination conditions. The first zone server may customize the traversal termination condition as any one of the following or a combination of at least two of the following:

Condition 1: encountering a traversal obstacle event at any predicted waypoint. The traversal obstacle event is an event that can block a virtual element from traversing. The virtual element may be a virtual object or a virtual prop, and different types of virtual elements may have the same or different traversal obstacle events. For example, the traversal obstacle event may be that a communication link between zone servers is faulty, or the traversal obstacle event may be that an originally predicted next zone server has been split and consequently a destination is illegal. The traversal obstacle event may be preconfigured.

According to an aspect, because a transmission process of the one-way transmission event signal between different zone servers is not instantaneously completed, each time the one-way transmission event signal traverses to a new node representing a zone server, the one-way transmission event signal participates in a service logic operation of a current calculation period of the zone server. If no traversal obstacle event is detected in the current calculation period, the one-way transmission event signal continues to traverse to a next node; otherwise, the one-way transmission event signal stops traversing.

As shown in FIG. 9, each time the one-way transmission event signal traverses to a new node representing a zone server, the one-way transmission event signal participates in a service logic operation of a current calculation period of the zone server. This means that each time the one-way transmission event signal traverses to a new triangle including a shadow, the one-way transmission event signal participates in a service logic operation of a current calculation period of a zone server represented by the triangle including a shadow. For example, in a process of traversing the one-way transmission event signal from the node 91 to the node 99, the node 91 is a first zone server and the node 99 is a second zone server, but an intermediate zone server, that is, a node 94, is encountered in the traversal process. In this case, when the one-way transmission event signal reaches the node 94, the one-way transmission event signal participates in a service logic operation of a calculation cycle of the intermediate zone server at an arrival time. Only if no traversal obstacle event is detected in this calculation cycle, the one-way transmission event signal can continue to traverse from the node 94 to the node 99. Otherwise, the one-way transmission event signal uses the intermediate zone server as a second zone server, that is, the node 94 is selected as a predicted end point, and stays on the node 94 because the traversal obstacle event is encountered.

Condition 2: traversal energy of the one-way transmission event signal at any predicted waypoint is less than a traversal threshold. According to an aspect, the one-way transmission event signal also has bound virtual energy. The virtual energy of the one-way transmission event signal and the virtual energy of the diffusion event signal may be virtual energy of a same type or virtual energy of different types. Two different types of virtual energy are used as an example for description. That is, the diffusion event signal and the one-way transmission event signal that are sent by the same virtual object consume different types of virtual energy. For ease of distinguishing herein, the virtual energy consumed by the one-way transmission event signal is referred to as “traversal energy”.

According to an aspect, the traversal energy is a value calculated through conversion in real time according to an attribute of a virtual object controlled by a user. In this way, as long as attributes of different virtual objects are different, one-way transmission event signals that are sent have different traversal energy, so that playing methods based on the one-way transmission event signal are more diversified, and the human-computer interaction efficiency is improved. A technical person may define a formula based on an attribute and traversal energy. Formulas may differ based on to sects, equipment, attributes, skills, and the like of virtual objects. This is not specifically limited herein. In an example, when creating a virtual object in a virtual world, a user allocates traversal energy of a fixed value to the virtual object. The user may control the virtual object to execute a task, make contribution, and the like in the virtual world, and obtain more traversal energy according to a preset service rule, or may consume a virtual resource to exchange for or purchase traversal energy. A manner of obtaining the traversal energy is not limiting.

According to an aspect, the one-way transmission event signal can complete a next traversal only when the traversal energy is not less than a traversal threshold. Otherwise, if the traversal energy on any predicted waypoint is less than the traversal threshold, the one-way transmission event signal stops traversal.

Returning to FIG. 9, each time the one-way transmission event signal reaches a predicted waypoint (which may be a zone server or a message transit node), whether traversal energy is less than a traversal threshold is detected. If the traversal energy is less than the traversal threshold, and the predicted waypoint is an intermediate zone server, the one-way transmission event signal stays in the intermediate zone server, and a virtual element associated with the one-way transmission event signal stays in a virtual sub-world associated with the intermediate zone server. If the predicted waypoint is a message transit node, the one-way transmission event signal stays in a previous intermediate zone server adjacent to the message transit node, or the one-way transmission event signal is allowed to continue to traverse for the last time and stay in a next zone server adjacent to the message transit node. In this way, it can be avoided that the one-way transmission event signal is stuck in the message transit node. For example, when the predicted waypoint is a message transit node, a virtual element associated with the one-way transmission event signal stays in a virtual sub-world associated with a previous intermediate zone server adjacent to the message transit node, or the virtual element associated with the one-way transmission event signal is allowed to traverse for the last time and stay in a virtual sub-world associated with a next zone server adjacent to the message transit node.

For example, in a process of traversing a one-way transmission event signal from the node 91 to the node 99, the node 91 is a first zone server and the node 99 is a second zone server, but an intermediate zone server, such as the node 94, is encountered in the traversal process. For example, when the one-way transmission event signal reaches the node 94, it is found that the traversal energy is less than the traversal threshold. In this case, the intermediate zone server is used as a second zone server, that is, the node 94 is selected as a predicted end point, and the signal stays in the node 94 because the traversal energy is insufficient.

In another example, when the one-way transmission event signal reaches a message transit node 95, it is found that the traversal energy is less than the traversal threshold. In this case, a previous intermediate zone server closest to the message transit node 95, that is, an intermediate zone server represented by the node 94, is used as a second zone server, that is, the node 94 is selected as a predicted end point, and the signal stays in the node 94 because the traversal energy is insufficient. Alternatively, the message transit node 95 allows the one-way transmission event signal to traverse for the last time (the signal continues transmission when encountering a message transit node, and immediately stops when encountering a zone server), and the signal stops traversing when traversing to a next zone server, that is, the node 99, adjacent to the message transit node 95.

Condition 3: any predicted waypoint is located in the service zone server set.

According to an aspect, it may also be configured that the one-way transmission event signal stops traversal when encountering the first zone server on the topology propagation path. That is, each time the one-way transmission event signal reaches a predicted waypoint, it is detected whether the predicted waypoint is located in the service zone server set, so that whether the predicted waypoint is a zone server or a message transit node can be determined. Once a predicted waypoint is located in the service zone server set, it indicates that the first zone server is reached and traversal is stopped.

Returning to FIG. 9, each time the one-way transmission event signal reaches a predicted waypoint (which may be a zone server or a message transit node), it is detected whether the predicted waypoint is located in the service zone server set. If the predicted waypoint is located in the service zone server set, it indicates that the predicted waypoint is a zone server, and it indicates that the first zone server is reached and traversal is stopped. For example, when the one-way transmission event signal reaches the node 92 and the node 93 after starting from the node 91, because both the node 92 and the node 93 are message transit nodes, the one-way transmission event signal continues to traverse. However, when the one-way transmission event signal reaches the node 94, because the node 94 is an intermediate zone server and is located in the service zone server set, the one-way transmission event signal stops traversal when reaching the node 94. In addition, the intermediate zone server represented by the node 94 is used as a second zone server, the node 94 is selected as a predicted end point, and a virtual element associated with the one-way transmission event signal is controlled to be displayed in a game picture of the second zone server.

Condition 4: a quantity of traversals of the one-way transmission event signal is greater than or equal to a quantity limit of traversals.

According to an aspect, a quantity limit of traversals may also be preset. The quantity limit of traversals is set according to a service requirement, and may be reset or increased or decreased according to behavior of a virtual object in the virtual world. Each time the one-way transmission event signal reaches a predicted waypoint, whether a current quantity of traversals is less than a quantity limit of traversals is determined. If the quantity of traversals is less than the quantity limit of traversals, the one-way transmission event signal is allowed to continue to traverse to a next predicted waypoint, and if the quantity of traversals is greater than or equal to the quantity limit of traversals, the one-way transmission event signal is controlled to stop traversing. In this case, if the current predicted waypoint is an intermediate zone server, the one-way transmission event signal stays in the intermediate zone server. If the current predicted waypoint is a message transit node, the one-way transmission event signal stays in a previous intermediate zone server adjacent to the message transit node, or the one-way transmission event signal is allowed to continue to traverse for the last time and stay in a next zone server adjacent to the message transit node. In this way, it can be avoided that the one-way transmission event signal is stuck in the message transit node.

Returning to FIG. 9, each time the one-way transmission event signal reaches a predicted waypoint (which may be a zone server or a message transit node), it is detected whether a current quantity of traversals is less than a quantity limit of traversals, and the one-way transmission event signal is allowed to continue to traverse only when the current quantity of traversals is less than the quantity limit of traversals. For example, the quantity limit of traversals is 10. In a process of traversing the one-way transmission event signal from the node 91 to the node 99, because a total quantity of traversals is 8 and is less than the quantity limit of traversals, that is, 10, the one-way transmission event signal successfully reaches the node 99, and the second zone server indicated by the node 99 is a selected predicted end point. For another example, the quantity limit of traversals is 7. In a process of traversing the one-way transmission event signal from the node 91 to the node 99, because a total quantity of traversals is 8 and is greater than the quantity limit of traversals, that is, 7. Therefore, the one-way transmission event signal cannot successfully traverse to the node 99. This is because when reaching the node 98, the one-way transmission event signal stops because the quantity of traversals is greater than the quantity limit of traversals. Therefore, the one-way transmission event signal stays in a previous intermediate zone server closest to the node 98, that is, the node 94. Therefore, the node 94 is selected as a predicted end point. Alternatively, the one-way transmission event signal is allowed to traverse for the last time, and stops traversing when traversing to a next zone server, that is, the node 99, adjacent to the message transit node 98.

According to operations 8031 and 8032, a possible implementation of how to determine the predicted waypoint on the topology propagation path of the one-way transmission event signal is provided. In a process of determining the topology propagation path, the first zone server performs calculation only for the first predicted waypoint, and when the one-way transmission event signal reaches each predicted waypoint, the predicted waypoint then performs calculation for a next predicted waypoint. In this way, the first zone server does not need to sense a node not connected to the first zone server, only needs to maintain service logic in a virtual time zone of the first zone server, and periodically receives an event signal from and sends an event signal to a logically connected node. Therefore, maintenance overheads of the first zone server are relatively low.

805: Determine a topology propagation path of the one-way transmission event signal in the service zone server set based on the path start point, the predicted waypoints determined before the predicted end point, and the predicted end point.

For example, the topology propagation path of the one-way transmission event signal has a unique branch, and the branch is a branch that starts from the path start point, passes through the predicted waypoint determined before the predicted end point, and reaches the predicted end point.

In the foregoing process, the one-way transmission event signal is used as an example, to describe how to determine the topology propagation path of the one-way transmission event signal in the service zone server set based on the preset propagation parameter of the one-way transmission event signal. Specifically, the preset propagation parameter of the one-way transmission event signal includes an initial propagation direction and traversal path information. In this way, all predicted waypoints on a unique branch can be determined, and then a predicted end point is selected from all the predicted waypoints according to a customized traversal termination condition, so as to determine a unique branch from the path start point to the predicted end point as the topology propagation path. A connection edge between different nodes in the topology propagation path is a directed edge, and a direction of the directed edge represents each propagation direction of the one-way transmission event signal.

806: Transmit, along the topology propagation path, the one-way transmission event signal from the first zone server to the second zone server indicated by the predicted end point.

The one-way transmission event signal participates in a service logic operation of the second zone server after reaching the second zone server.

According to an aspect, after the topology propagation path of the one-way transmission event signal is determined in operations 803 to 805, the one-way transmission event signal may be sent from the first zone server to the first predicted waypoint. Then, the one-way transmission event signal is sent from the first predicted waypoint to the second predicted waypoint, and so on, so that the one-way transmission event signal may be successively sent to the second zone server indicated by the predicted end point. The second zone server is a zone server satisfying the traversal termination condition. Because the topology propagation path of the one-way transmission event signal has a unique branch, the one-way transmission event signal has only one predicted end point. The event signal of the one-way transmission event participates in a service logic operation of the second zone server only after reaching the second zone server, and the second zone server does not sense the one-way transmission event signal before the event signal of the one-way transmission event reaches the second zone server.

In a transmission process of the one-way transmission event signal, because the predicted waypoint may be a zone server or a message transit node, each time the one-way transmission event signal reaches a predicted waypoint representing a zone server, the one-way transmission event signal also participates in a service logic operation of the zone server represented by the predicted waypoint. In the topology propagation path shown in FIG. 9, the one-way transmission event signal participates in a service logic operation of each node representing a zone server. For example, the one-way transmission event signal is a traversal event of a virtual object between different zone servers. In this case, when the virtual object traverses to an intermediate zone server represented by the node 94, the virtual object participates in a service logic operation of the intermediate zone server in a calculation period of an arrival time, and then continues to traverse from the node 94 to the second zone server represented by the node 99.

In the foregoing process, a cross-zone-server traversal mechanism that can be freely triggered by a virtual object in a virtual world at any time is provided. This cross-zone-server traversal mechanism does not involve migration of player data between different zone servers, and instead data is conveniently transmitted in the virtual world in a form of one-way transmission event signal, and the virtual object may freely walk between virtual sub-worlds of different zone servers. In this way, a cross-zone-server interaction manner of a cloud game is greatly improved, and human-computer interaction efficiency is greatly improved.

According to an aspect, when the one-way transmission event signal propagates along the topology propagation path, each time the one-way transmission event signal reaches a predicted waypoint, traversal energy of the one-way transmission event signal is deducted by energy consumed by one traversal. According to an aspect, an equal amount of energy may be deducted for each traversal of the one-way transmission event signal. In this way, calculation efficiency of latest traversal energy can be conveniently improved. According to an aspect, each time a predicted waypoint is reached, energy consumed by current traversal of the one-way transmission event signal is calculated according to a preset deduction rule. For example, the deduction rule is set as follows: a larger current quantity of traversals indicates more energy consumption. In another example, the deduction rule is set as follows: energy consumed by traversing to the zone server is greater than energy consumed by traversing to the message transit node. Other deduction rules may be possible.

All the foregoing optional technical solutions may be combined in different manners. According aspects described herein, a message transmission mechanism across zone servers using an event signal as a carrier is constructed between zone servers of the virtual world, and a topology propagation path having a unique branch is customized for a one-way transmission event signal. The first zone server only needs to configure an initial propagation direction and traversal path information, so that the one-way transmission event signal can spontaneously traverse to the second zone server along the unique branch, and stop traversal when a traversal termination condition is satisfied. This can ensure that the event signal of the one-way transmission event has the interaction mechanism across zone servers. In addition, this can ensure that the one-way transmission event signal is not continuously transmitted in the zone servers without stopping, so that cross-zone-server interaction can be implemented for the one-way transmission event signal in the virtual world, thereby greatly improving transmission efficiency of a message transmitted by using the one-way transmission event signal as a carrier.

According to aspects described herein, the message transmission mechanisms of a diffusion event signal and a one-way transmission event signal between different zone servers are respectively described. In the message transmission mechanisms, all zone servers in a virtual world are connected to each other, and all the zone servers run a game at the same time, and perform a service logic operation in a virtual time zone of the zone server as a local inertial frame. In this way, a virtual element and an event can freely move in all the zone servers, for example, a player can control a virtual object to traverse across zone servers, and a player can also control a virtual prop to traverse across zone servers, which has a high degree of freedom and strong playability.

According to an aspect, each zone server in the service zone server set includes a plurality of computing units, and the plurality of computing units are all located in a virtual time zone of the zone server. That is, all computing units in the same zone server are located in the same virtual time zone. The virtual time zone refers to a clock shared by all computing units maintained by the zone server. In addition, all computing units in the same zone server can access a shared storage region (providing a data reading function) of the zone server. Each computing unit has a unique associated sub-region in the shared storage region, and may write data to the sub-region (providing a data writing function). The access efficiency of each computing unit within the zone server can be improved. For any event signal, a topology transmission path of the event signal may be determined based on a type of the event signal, so that the event signal is transmitted between different computing units in the zone server according to the topology transmission path in the zone server.

A message transmission mechanism across zone servers using an event signal as a carrier is constructed between computing units of a zone server, and a topology propagation path is customized for an event signal, so as to ensure that the event signal can be transmitted between different computing units, thereby implementing cross-computing-unit interaction of the event signal, and greatly improving transmission of a message in the same zone server transmitted by using the event signal as a carrier. When types of event signals are different, topology propagation paths of the event signals are also different; therefore, propagation procedures of a diffusion event signal and a one-way transmission event signal in different computing units of the same zone server in a virtual world are respectively described below.

FIG. 10 is a flowchart of an event signal transmission method according to aspects described herein. In FIG. 10, an event type of an event carried in an event signal is a diffusion event (e.g., the event signal is a diffusion event signal) is used to show a transmission mechanism of the diffusion event signal between different computing units of the same zone server. Each zone server is uniquely associated with one virtual sub-world in a virtual world, and transmission of a diffusion event signal between different computing units of the same zone server is equivalent to transmission of a diffusion event within the virtual sub-world associated with the zone server. Using any zone server in a service zone server set as an example, the zone server includes at least two computing units that are logically connected, and the at least two computing units include a first computing unit and a second computing unit. A transmission method for the diffusion event signal includes the following operation 1001 to operation 1005:

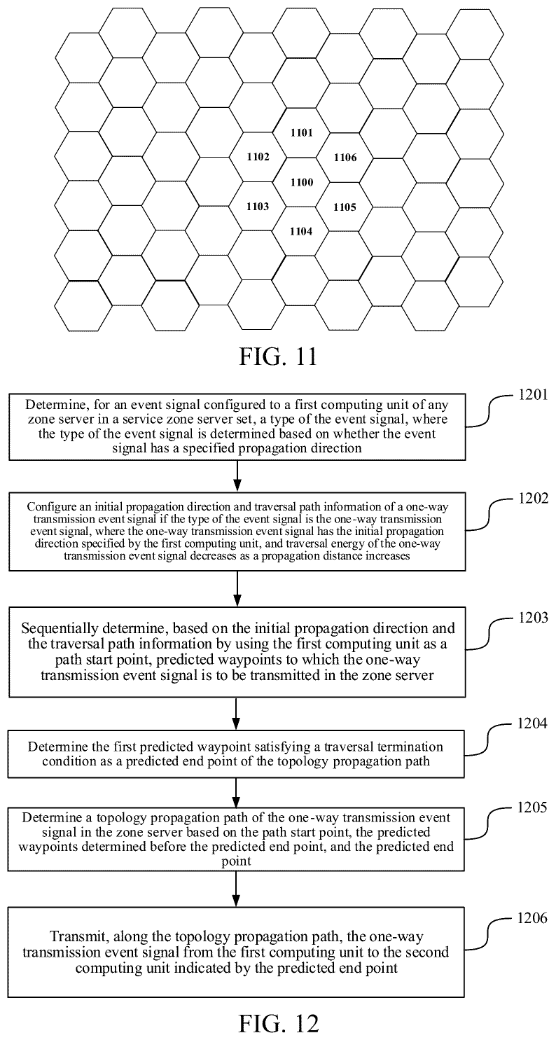

1001: Determine, for an event signal configured to a first computing unit of any zone server in a service zone server set, a type of the event signal, where the type of the event signal is determined based on whether the event signal has a specified propagation direction. Operation 1001 maybe similar to operation 501. FIG. 11 is a structural diagram of a topology within a zone server according to aspects described herein. As shown in FIG. 11, all computing units in the zone server may be in a cellular distribution, and this is different from distribution of a zone server in a topology space of a virtual world. Therefore, the topology space of the virtual world is divided into zone servers and message transit nodes, but no message transit node is disposed in the zone server. All nodes in the zone server are computing units, and each computing unit is logically connected to an adjacent computing unit but is not logically connected to a non-adjacent computing unit. For example, a computing unit 1100 is logically connected to 6 surrounding computing units 1101 to 1106, but is not logically connected to other computing units. For a computing unit located in the boundary of a zone server, a quantity of computing units logically connected to the computing unit is less than 6.

1002: Configure an initial energy value and a termination threshold of a diffusion event signal in a case that the type of the event signal is the diffusion event signal, where the diffusion event signal has no specified propagation direction, and virtual energy of the diffusion event signal decreases as a propagation distance increases. Operation 1002 is the same as operation 502. Details are not described herein again.

1003: Determine at least one path waypoint and at least one path end point of the diffusion event signal on a topology propagation path of the zone server by using the first computing unit as a path start point, where a value obtained after attenuation of the initial energy value when the diffusion event signal reaches the at least one path end point is less than the termination threshold. Each path waypoint and each path end point are computing units in the zone server. Operation 1003 is the same as operation 503. Details are not described herein again.

1004: Determine the topology propagation path of the diffusion event signal in the zone server based on the path start point, the at least one path waypoint, and the at least one path end point. Operation 1004 is the same as operation 504. Details are not described herein again.

1005: Transmit, along the topology propagation path, the diffusion event signal from the first computing unit to at least one second computing unit indicated by the at least one path end point. The diffusion event signal participates in a service logic operation of the second computing unit after reaching the second computing unit. Operation 1005 is the same as operation 505. Details are not described herein again. Information transmission and interaction within the same zone server may also be performed between different computing units within the zone server by using an event signal. In essence, event signal transmission within the zone server is cross-computing-unit event transmission. For a diffusion event signal, each computing unit propagates the diffusion event signal to all computing units other than a source direction, and virtual energy of the diffusion event signal attenuates as a propagation distance increases. In this way, a signal of an event such as a notification message in the zone server may be used as the diffusion event signal to perform cross-computing-unit message transmission within the zone server. A process in which a diffusion event signal is transmitted across computing units of the same zone server needs to be completed in the same calculation period of a virtual time zone of the zone server. This serves to avoid that the same diffusion event signal spans different calculation periods and consequently causes error in a service logic operation of the zone server, and ensures that high service availability is still externally ensured when transmission of the diffusion event signal across computing units is supported in the zone server.

All the foregoing optional technical solutions may be combined in different manners. According to aspects described herein, a message transmission mechanism across computing units using an event signal as a carrier is constructed between computing units of the same zone server of the virtual world, and a non-directional propagation direction is customized for a diffusion event signal. The first computing unit only needs to configure an initial energy value and a termination threshold, so that the diffusion event signal can be spontaneously broadcast to all connection directions, and stop broadcast when virtual energy is less than the termination threshold. This can ensure that the event signal of the diffusion event can be transmitted across different computing units of the current zone server along the topology propagation path. In addition, this can ensure that the diffusion event signal is not transmitted in the virtual sub-world of the current zone server without stopping, so that cross-computing-unit interaction can be implemented for the diffusion event signal within the virtual sub-world, thereby greatly improving transmission efficiency of a message in the same zone server transmitted by using the diffusion event signal as a carrier.

According to aspects described herein, a transmission mechanism of the diffusion event signal between different computing units of the same zone server in the service zone server set is briefly described. However, according to other aspects described herein, another one-way transmission event other than the diffusion event is used as an example, and a transmission mechanism of a one-way transmission event signal between different computing units of the same zone server is described.

FIG. 12 is a flowchart of an event signal transmission method according to aspects described herein. Referring to FIG. 12, using any zone server in a service zone server set as an example, the zone server includes at least two computing units that are logically connected, and the at least two computing units include a first computing unit and a second computing unit. A transmission method for the one-way transmission event signal includes the following operation 1201 to operation 1206:

1201: Determine, for an event signal configured to a first computing unit of any zone server in a service zone server set, a type of the event signal, where the type of the event signal is determined based on whether the event signal has a specified propagation direction. Operation 1201 may be similar to operation 801.

1202: Configure an initial propagation direction and traversal path information of a one-way transmission event signal if the type of the event signal is the one-way transmission event signal, where the one-way transmission event signal has the initial propagation direction specified by the first computing unit, and traversal energy of the one-way transmission event signal decreases as a propagation distance increases. Operation 1202 may be similar to operation 802.

1203: Sequentially determine, based on the initial propagation direction and the traversal path information by using the first computing unit as a path start point, predicted waypoints to which the one-way transmission event signal is to be transmitted in the zone server. A predicted waypoint that the one-way transmission event has reached constitutes the topology propagation path at a current time. Each predicted waypoint is a computing unit in the zone server. Operation 1203 may be similar to operation 803.

1204: Determine the first predicted waypoint satisfying a traversal termination condition as a predicted end point of the topology propagation path. Operation 1204 may be similar to operation 804.

1205: Determine a topology propagation path of the one-way transmission event signal in the zone server based on the path start point, the predicted waypoints determined before the predicted end point, and the predicted end point. Operation 1205 may be similar to operation 805.

1206: Transmit, along the topology propagation path, the one-way transmission event signal from the first computing unit to the second computing unit indicated by the predicted end point. The one-way transmission event signal participates in a service logic operation of the second computing unit after reaching the second computing unit. Operation 1206 may be similar to operation 806.

Information transmission and interaction within the same zone server may also be performed between different computing units within the zone server by using an event signal. In essence, event signal transmission within a zone server is cross-computing-unit event transmission. For a one-way transmission event signal, each predicted waypoint selects a determined propagation direction as indicated by the traversal path information, to send the one-way transmission event signal, and energy of the one-way transmission event signal is deducted each time after traversal. However, a virtual element associated with the one-way transmission event signal does not attenuate as a propagation distance increases. The virtual element is similar to a virtual mass, and a virtual element for game picture rendering is involved in the zone server. In this way, transmission of the virtual element between computing units may be considered as transmission of the one-way transmission event signal with a virtual mass between computing units. In this way, a signal of a flight event that a virtual arrow spans across computing units in a virtual sub-world, or a signal of a shooting event that a virtual object fires at a position indicated by a front sight may be used as a one-way transmission event signal to perform cross-computing-unit message transmission in a zone server. A process in which a one-way transmission event signal is transmitted across computing units of the same zone server needs to be completed in the same calculation period of a virtual time zone of the zone server. This serves to avoid that the same one-way transmission event signal spans different calculation periods and consequently causes error in a service logic operation of the zone server, and ensures that high service availability is still externally ensured when transmission of the one-way transmission event signal across computing units is supported in the zone server.

All the foregoing optional technical solutions can be combined in different manners. According aspects described herein, a message transmission mechanism across computing units using an event signal as a carrier is constructed between computing units of the same zone server of the virtual world, and a topology propagation path having a unique branch is customized for a one-way transmission event signal. The first computing unit only needs to configure an initial propagation direction and traversal path information, so that the one-way transmission event signal can spontaneously traverse to the second computing unit along the unique branch, and stop traversal when a traversal termination condition is satisfied. This can ensure that the event signal of the one-way transmission event has the interaction mechanism across computing units. In addition, this can ensure that the one-way transmission event signal is not continuously transmitted in the computing unit without stopping, so that cross-computing-unit interaction can be implemented for the one-way transmission event signal within the zone server of the virtual world, thereby greatly improving transmission efficiency of a message in the same zone server transmitted by using the one-way transmission event signal as a carrier.

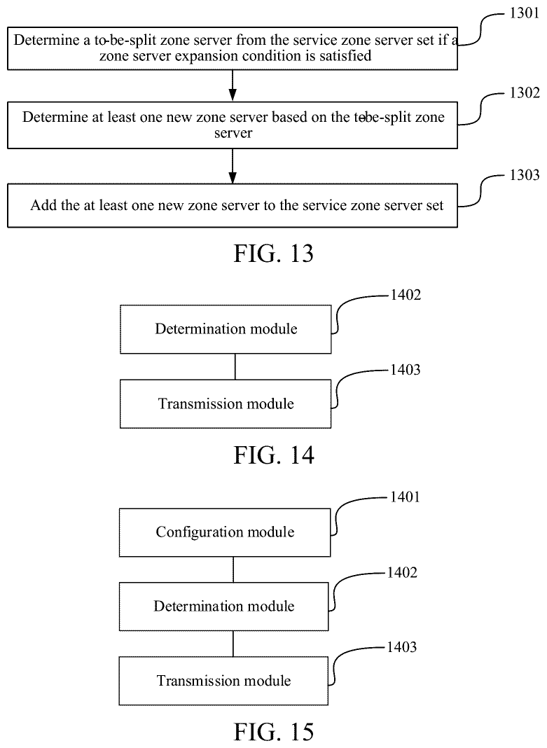

According to aspects described herein, message transmission mechanisms of a diffusion event signal within a zone server and between zone servers and message transmission mechanisms of a one-way transmission event signal within a zone server and between zone servers are respectively described. FIG. 13 is a flowchart of a zone server expansion method according to aspects described herein. FIG. 13 depicts a zone server expansion process of any to-be-split zone server in the service zone server set is described. As has been described above in description of FIG. 2 and FIG. 3, zone server expansion is a basic property of a virtual world. Similar to the Big Bang, the virtual world spontaneously expands zone servers without human interference from the outside. The following operation 1301 to operation 1303 are described by using a zone server expansion process as an example:

1301: Determine a to-be-split zone server from the service zone server set if a zone server expansion condition is satisfied.

According to an aspect, a technical person presets the zone server expansion condition. For example, the zone server expansion condition includes at least one of the following: an interval between a current time and a time at which the to-be-split zone server is determined last time reaches a reference time length; a quantity of virtual objects in any zone server exceeds a capacity of the zone server; and a quantity of idle computing units in any zone server is less than a reference threshold. The zone server expansion condition is not limiting. The reference time length, the capacity of the zone server, the reference threshold, and/or other factors may be preset or may be flexibly adjusted as necessary.

According to an aspect, the to-be-split zone server is determined from the service zone server set if the zone server expansion condition is satisfied. For example, if a zone server expansion condition is an interval of a reference time length (that is, an interval between a current time and a time at which a to-be-split zone server is previously determined is a reference time length), one or more zone servers are randomly selected from the service zone server set as to-be-split zone servers at an interval of the reference time length. For another example, if the zone server expansion condition is that a quantity of virtual objects in any zone server exceeds a zone server capacity, when it is detected that a quantity of virtual objects in any zone server exceeds the zone server capacity, the detected zone server is used as a to-be-split zone server. For another example, if the zone server expansion condition is that a quantity of idle computing units in any zone server is less than a reference threshold, when it is detected that a quantity of idle computing units in any zone server is less than the reference threshold, the detected zone server is used as a to-be-split zone server.

1302: Determine at least one new zone server based on the to-be-split zone server. For example, based on the to-be-split zone server, in addition to at least one new zone server, at least one message transit node is further determined. The message transit node performs a function of transmitting an event signal and does not represent a zone server. According to an aspect, for each to-be-split zone server determined in operation 1301, at least one new zone server and at least one message transit node may be determined in the topology space of the virtual world. Using FIG. 3 as an example, assuming that the node 202 is a zone server, when the node 202 meets a zone server expansion condition, the node 202 may be used as a to-be-split zone server, to generate one new zone server A and three new message transit nodes B, C, and D. According to an aspect, Each time a zone server (or a message transit node) is split into four parts on the spherical surface, a central part may be used as a new zone server, and surrounding parts may be used as new message transit nodes. In this way, both an existing zone server and an existing message transit node can be repeatedly split in a same manner to generate new nodes, so that a virtual world can expand infinitely.

1303: Add the at least one new zone server to the service zone server set. According to an aspect, all the new zone servers generated through splitting in operation 1302 are added to the service zone server set, but a new message transit node does not need to be added to the service zone server set. In this way, after the new zone server is added to the service zone server set, a diffusion event signal and a one-way transmission event signal may also be transmitted to the new zone server, ensuring high availability of the new zone server. From the perspective of surface area, this splitting manner seems to have no expansion (that is, a volume of the sphere is not increased). However, because a message transmission speed between two nodes is constant, splitting into more small blocks increases a message transmission path between zone servers, which is similar to that galaxies in a universe move away from each other. Therefore, in essence, the virtual world continuously expands in this manner. Through expansion of the virtual world, more users can control virtual objects to interact in the virtual world, thereby improving a human-computer interaction rate.

According to aspects described herein, for a virtual world based on a cloud game, complete hardware deployment and software implementation solutions are provided, to construct a cloud game world that has no boundary and limitation and that can implement infinite expansion of zone servers and infinite expansion of players and that can be infinitely passed through. In the cloud game world, a quantity of zone servers can be infinitely increased, and virtual objects controlled by players can infinitely pass through virtual sub-worlds corresponding to different zone servers. Hardware connections may be performed between servers or server clusters of different zone servers in a manner corresponding to logical division, a virtual sub-world allocated to each zone server from a virtual world is independently run on a server or a server cluster of the zone server, and message transmission across virtual sub-worlds is implemented based on an event mechanism in different zone servers. In addition, a hardware topology structure also expands as a zone server in a virtual world expands, and each virtual element is transmitted according to a position of the virtual element in the topology space, so that the one-way transmission event signal is transmitted between server clusters of different zone servers, so as to implement changes of game pictures on game clients of different players.

In a virtual world, an event is the most basic information particle in the zone server and the virtual world and cannot be divided again. As can be known from the event signal transmission rule between computing units, an event signal in a zone server is in a basic computing unit or in a process of being transmitted to another basic computing unit. Similarly, because an event is a manner in which virtual elements in a game interact with each other and statuses of all virtual elements in the game are finally presented to a user in a game picture, both a virtual object controlled by a player and a virtual prop or a virtual object in a virtual world can interact and convert with the event as a virtual element. All virtual elements continuously visible within a viewing angle of a virtual object are rendered by a GPU and constitute a game picture that can be seen by a player, and a plurality of frames of consecutive game pictures constitute a game video stream that is sent by a cloud game to a player terminal.

All computing units in the same zone server have a shared clock, are in the same virtual time zone, and perform event signal processing according to a uniform calculation cycle, ensuring consistency of service logic operation results in the zone server. Each zone server may determine a calculation period of the zone server according to calculation power of a hardware device. Within a calculation period, all computing units need to complete processing of all event signals inside, and after the processing is completed, all virtual elements can form a result status of the calculation period, so that a final game picture can be obtained. Therefore, the calculation period of each zone server is equivalent to an interval between two adjacent game picture frames in the zone server, and a length of the calculation period affects a frame rate of a game video stream in the zone server. All events and virtual elements in the same zone server constitute a virtual sub-world in the zone server, and virtual sub-worlds of all zone server are spliced to form a virtual world of an entire cloud game. Each player terminal obtains a game picture rendered in a result status of a current calculation period for all events and virtual elements seen within a viewing angle of a virtual object of the player terminal. Each zone server further obtains a state snapshot of all virtual elements after each calculation period ends, and the state snapshot records event description vectors of all virtual elements. Regardless of whether the virtual element moves between zone servers or within a zone server, the virtual element first needs to be converted into an event signal. After being converted into the event signal, the event signal no longer participates in rendering of a game picture in an original zone server, as if the event signal disappears from a virtual sub-world of the original zone server. Only after the event signal is moved and reaches a new zone server, and the event signal is converted into a virtual element again in the new zone server and traverses to a virtual sub-world of the new zone server, the virtual element participates in rendering of a game picture in the new zone server.

FIG. 14 is a schematic structural diagram of an event signal transmission apparatus according to aspects described herein. As shown in FIG. 14, the apparatus includes: a determination module 1402, configured to determine, for an event signal configured to a first zone server in a service zone server set, a topology propagation path of the event signal in the service zone server set based on a preset propagation parameter of the event signal, the topology propagation path being a propagation path from the first zone server to a second zone server in the service zone server set, the second zone server being specified by the first zone server or being determined from the service zone server set based on the preset propagation parameter, and the preset propagation parameter indicating at least one of a propagation direction or a propagation mode of the event signal; and a transmission module 1403, configured to transmit the event signal from the first zone server to the second zone server along the topology propagation path.

According aspects described herein, a message transmission mechanism across zone servers using an event signal as a carrier is constructed between zone servers of a virtual world, the preset propagation parameter is customized for the event signal, and the topology propagation path of the event signal can be determined according to the preset propagation parameter, thereby ensuring that the event signal can be transmitted between different zone servers, and implementing transmission of the event signal across zone servers. In this way, even if a virtual object controlled by a user is located in different zone servers in the virtual world, the user can perform interaction across zone servers through transmission of the event signal across zone servers, thereby improving interaction efficiency, interaction experience of the user, and a human-computer interaction rate. In addition, because a message can be transmitted by using an event signal as a carrier, the message transmission efficiency can be greatly improved.

FIG. 15 is a schematic structural diagram of an event signal transmission apparatus according to aspects described herein. The event signal transmission apparatus further comprises: a configuration module 1401, configured to configure, based on a type of the event signal, a preset propagation parameter matching the type, where the type is determined based on whether the event signal has a specified propagation direction. The determination module 1402 is configured to determine the topology propagation path of the event signal in the service zone server set based on the preset propagation parameter that is of the event signal and that matches the type.

According to an aspect, the configuration module 1401 is configured to: configure an initial energy value and a termination threshold of a diffusion event signal in a case that the type is the diffusion event signal, where virtual energy of the diffusion event signal decreases as a propagation distance increases, the diffusion event signal has no specified propagation direction, the initial energy value represents an initial value of the virtual energy of the diffusion event signal, and the termination threshold represents an energy threshold that is of the virtual energy and that is at a time when the diffusion event signal stops propagating.

According to an aspect, and similar to the apparatus composition in FIG. 14, the determination module 1402 includes: a first determination unit, configured to determine at least one path waypoint and at least one path end point of the diffusion event signal by using the first zone server as a path start point, where a value obtained after attenuation of the initial energy value when the diffusion event signal reaches the at least one path end point is less than the termination threshold; and determine the topology propagation path of the diffusion event signal in the service zone server set based on the path start point, the at least one path waypoint, and the at least one path end point.

According to an aspect, the first determination unit is configured to: determine, by using the first zone server as a path start point, a first-order propagation direction of the diffusion event signal, a path waypoint of the diffusion event signal in the first-order propagation direction, and a first-order energy value obtained after attenuation of the initial energy value after the diffusion event signal is propagated for the first time in the first-order propagation direction; determine, based on the path waypoint in the first-order propagation direction if the first-order energy value is not less than the termination threshold, a second-order propagation direction of the diffusion event signal, a path waypoint of the diffusion event signal in the second-order propagation direction, and a second-order energy value obtained after attenuation of the initial energy value after the diffusion event signal is propagated for the second time in the second-order propagation direction; and set the path waypoint in the second-order propagation direction as the path end point if the second-order energy value is less than the termination threshold.

According to an aspect, each time the diffusion event signal is propagated, virtual energy before propagation of the diffusion event signal is equally divided, based on a quantity of propagation directions of current propagation, into equal parts conforming to the quantity.

According to an aspect, virtual energy of the diffusion event signal is combined according to quantities of times of reception if any path waypoint on the topology propagation path receives the same diffusion event signal for a plurality of times.

According to an aspect, the configuration module 1401 is configured to: configure an initial propagation direction and traversal path information of a one-way transmission event signal if the type is the one-way transmission event signal, where traversal energy of the one-way transmission event signal decreases as a propagation distance increases, the one-way transmission event signal has the initial propagation direction specified by the first zone server, and the traversal path information represents a change rule of a propagation direction in propagation of the one-way transmission event signal.

According to an aspect, and similar to the apparatus composition in FIG. 14, the determination module 1402 includes: a second determination unit, configured to sequentially determine, based on the initial propagation direction and the traversal path information by using the first zone server as a path start point; predicted waypoints to which the one-way transmission event signal is to be transmitted; and a third determination unit, configured to determine the first predicted waypoint satisfying a traversal termination condition as a predicted end point; and determine a topology propagation path of the one-way transmission event signal in the service zone server set based on the path start point, the predicted waypoints determined before the predicted end point, and the predicted end point.

According to an aspect, the second determination unit is configured to: determine the first predicted waypoint of the one-way transmission event signal based on the initial propagation direction by using the first zone server as a path start point; and sequentially determine, based on the first predicted waypoint and the traversal path information, predicted waypoints of the one-way transmission event signal that are after the first predicted waypoint.

According to an aspect, the traversal termination condition includes at least one of the following: encountering a traversal obstacle event at any predicted waypoint; traversal energy of the one-way transmission event signal at any predicted waypoint is less than a traversal threshold; any predicted waypoint is located in the service zone server set; and a quantity of traversals of the one-way transmission event signal is greater than or equal to a quantity limit of traversals.

According to an aspect, the traversal path information includes traversal indication information respectively corresponding to a plurality of propagations, and traversal indication information corresponding to any one of the propagations indicates a change rule of a propagation direction of the one-way transmission event signal in the any one of the propagations; and the change rule is rotating clockwise relative to a propagation direction of the one-way transmission event signal in previous propagation, or rotating anticlockwise relative to a propagation direction of the one-way transmission event signal in previous propagation.

According to an aspect, when the one-way transmission event signal propagates along the topology propagation path, each time the one-way transmission event signal reaches a predicted waypoint, traversal energy of the one-way transmission event signal is deducted by energy consumed by one traversal.

According to an aspect, the one-way transmission event signal is a signal of a cross-zone-server traversal event of a virtual object in the service zone server set; or the one-way transmission event signal is a signal of a cross-zone-server traversal event that is of a virtual prop fired by a virtual object and that is in the service zone server set.

According to an aspect, any zone server in the service zone server set includes a plurality of computing units, wherein the plurality of computing units are all located in a virtual time zone of the zone server, and wherein an event signal is transmitted between different computing units of the zone server according to a topology transmission path within the zone server, and the topology transmission path is determined based on a type of the event signal.

According to an aspect, the plurality of computer units are in a cellular distribution.

According to an aspect, similar to the apparatus composition in FIG. 14, the apparatus further includes a zone server expansion module, configured to: determine a to-be-split zone server from the service zone server set if a zone server expansion condition is satisfied; determine at least one new zone server based on the to-be-split zone server; and add the at least one new zone server to the service zone server set.

According to an aspect, the zone server expansion condition includes at least one of the following: an interval between a current time and a time at which the to-be-split zone server is determined last time reaches a reference time length; a quantity of virtual objects in any zone server exceeds a capacity of the zone server; and a quantity of idle computing units in any zone server is less than a reference threshold.

All the foregoing optional technical solutions may be combined in different manners. For the event signal transmission apparatuses depicted in FIGS. 14 and 15, only division of the above functional modules is described by using examples. The functions may be also completed by different functional modules as required. To be specific, an internal structure of a computer device is divided into different functional modules to complete all or some of the functions described above. In addition, the event signal transmission apparatus may implement the event signal transmission method according to aspects described herein.

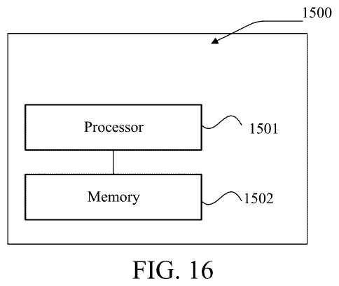

FIG. 16 is a schematic structural diagram of a computer device according to aspects described herein. A computer device 1500 may be implemented as a server of any zone server in a service zone server set, or implemented as a server in a server cluster of any zone server. The computer device 1500 may vary greatly due to different configurations or performance. Generally, the computer device 1500 includes: one or more processors 1501 and one or more memories 1502.

According to an aspect, the processor 1501 includes one or more processing cores, for example, a 4-core processor or an 8-core processor. According to an aspect, the processor 1501 may be implemented in at least one hardware form of a digital signal processor (DSP), a field-programmable gate array (FPGA), and a programmable logic array (PLA). According to an aspect, the processor 1501 includes a main processor and a coprocessor. The main processor is a processor configured to process data in an active state, also referred to as a CPU. The coprocessor is a processor with low power consumption configured to process data in a standby state. According to an aspect, the processor 1501 may be integrated with a GPU, and the GPU is responsible for rendering and drawing a content required to be displayed by a display screen. According to an aspect, the processor 1501 may further include an artificial intelligence (AI) processor. The AI processor is configured to process computing operations related to machine learning. According to an aspect, the memory 1502 includes one or more computer-readable storage mediums, and According to an aspect, the computer-readable storage medium is non-transitory. According to an aspect, the memory 1502 may further include a high-speed random access memory and a nonvolatile memory, for example, one or more disk storage devices or flash storage devices. According to an aspect, the non-transitory computer-readable storage medium in the memory 1502 is configured to store at least one computer program. The at least one computer program is configured to be loaded and executed by the one or more processors 1501, to implement the event signal transmission methods according to aspects described herein.

According to an aspect, the computer device 1500 further includes components such as a wired or wireless network interface, a keyboard, and an input/output interface, to facilitate input and output. The computer device 1500 further includes another component configured to implement a function of a device. Details are not further described herein. A person skilled in the art can understand that the structure shown in FIG. 16 does not constitute a limitation on the computer device 1500, and can include more or fewer components than those shown in the figure, or combine some components, or use different component arrangements.

For example, a non-volatile computer-readable storage medium is further provided, for example, a memory including at least one computer program. The at least one computer program may be executed by a processor in a computer device to complete the event signal transmission method according to aspects described herein. For example, the non-volatile computer-readable storage medium includes a read-only memory (ROM), a random access memory (RAM), a compact disc read-only memory (CD-ROM), a magnetic tape, a floppy disk, and an optical data storage device. In another example, a computer program product is further provided, including one or more computer programs stored in a non-volatile computer-readable storage medium. One or more processors of a computer device are capable of reading the one or more computer programs from the non-volatile computer-readable storage medium, and the one or more processors execute the one or more computer programs, so that the computer device can perform the event signal transmission method according to aspects described herein.

A person of ordinary skill in the art can understand that all or some aspects described herein may be implemented by hardware or a program instructing relevant hardware. According to an aspect, the program is stored in a computer readable storage medium. According to an aspect, the storage medium mentioned above is a read-only memory, a magnetic disk, an optical disc, or the like.

The foregoing descriptions are merely illustrative embodiments and aspects, and are not intended to limit this application except as otherwise claimed. Any modification, equivalent replacement, or improvement made within the principle of this application shall fall within the protection scope of the claims.

What is claimed is:

1. A computer implemented method, comprising:
determining, for an event signal originating from a first zone server in a service zone server set, a topology propagation path of the event signal in the service zone server set, wherein:
the topology propagation path is based on a preset propagation parameter of the event signal,
the topology propagation path is a propagation path from the first zone server to a second zone server in the service zone server set, wherein the second zone server is specified by the first zone server, and
the preset propagation parameter indicates at least one of a propagation direction or a propagation mode of the event signal; and
transmitting the event signal from the first zone server to the second zone server along the topology propagation path.

2. The method according to claim 1, further comprising:
configuring, based on the event signal having a specified propagation direction, a type of the event signal;
configuring, based on the type of the event signal, a preset propagation parameter; and
determining, based on the preset propagation parameter, a topology propagation path of the event signal in the service zone server set.

3. The method according to claim 2, wherein the event signal is a diffusion event signal and configuring the preset propagation parameter further comprises:
configuring an initial energy value and a termination threshold of the event signal, wherein:
the initial energy value represents an initial value of the virtual energy,
virtual energy of the diffusion event signal decreases as propagation distance increases, and
the termination threshold is an energy threshold, wherein the event signal stops propagating when the virtual energy does not satisfy the termination threshold.

4. The method according to claim 1, wherein determining the topology propagation path of the event signal in the service zone server set based on the preset propagation parameter further comprises:
determining, using the first zone server as a path start point, at least one path waypoint and at least one path end point of the event signal, wherein a termination energy value, obtained after attenuation of the initial energy value when the event signal reaches the at least one path end point, is less than the termination threshold; and
determining the topology propagation path of the event signal in the service zone server set based on the path start point, the at least one path waypoint, and the at least one path end point.

5. The method according to claim 4, wherein determining, using the first zone server as a path start point, at least one path waypoint and at least one path end point of the diffusion event signal further comprises:
determining a first-order propagation direction of the event signal, a path waypoint of the diffusion event signal in the first-order propagation direction, and a first-order energy value obtained after attenuation of the initial energy value after the event signal is propagated for the first time in the first-order propagation direction;
determining, based on the path waypoint, whether the first-order energy value is not less than the termination threshold;
based on the first-order energy value not being less than the termination threshold, determining a second-order propagation direction of the diffusion event signal, a path waypoint of the event signal in the second-order propagation direction, and a second-order energy value obtained after attenuation of the initial energy value after the event signal is propagated for the second time in the second-order propagation direction; and
based on the second-order energy value being less than the termination threshold, setting the path waypoint in the second-order propagation direction as the path end point.

6. The method according to claim 3, wherein transmitting the event signal further comprises:
dividing, before transmitting the event signal and based on a quantity of propagation directions, the virtual energy of the event signal into equal parts.

7. The method according to claim 6, further comprising:
receiving, at a given path waypoint on the topology propagation path, a plurality of event signals, wherein each event signal is received from a unique propagation direction; and
determining, by combining each virtual energy of each of the plurality of event signals, virtual energy corresponding the given path waypoint.

8. The method according to claim 2, wherein the event signal is a one-way transmission event signal, and wherein configuring a preset propagation parameter further comprises:
determining an initial propagation direction and a traversal path information of the event signal, wherein:
traversal energy of the event signal decreases as propagation distance increases,
the initial propagation direction is specified by the first zone server, and,
the traversal path information represents a change rule of a propagation direction in propagation of the event signal.

9. The method according to claim 8, wherein determining the topology propagation path of the event signal further comprises:
predicting, based on the initial propagation direction and the traversal path information and using the first zone server as a path start point, a plurality of waypoints;
predicting, based on the plurality of waypoints, an end point, wherein the end point is a waypoint in the plurality of waypoints that satisfies a traversal termination condition; and
determining a topology propagation path of the event signal based on the path start point, the plurality of waypoints, and the end point.

10. The method according to claim 9, wherein predicting the plurality of waypoints further comprises:
determining a first waypoint of the event signal, wherein determining the first waypoint is based on the initial propagation direction and using the first zone server as a path start point; and
predicting, based on the first waypoint and the traversal path information, the plurality of waypoints after the first waypoint.

11. The method according to claim 9, wherein the traversal termination condition is at least one of the following:
encountering a traversal obstacle event at a waypoint;
traversal energy of the event signal at a waypoint is less than a traversal threshold;
a waypoint is not located in the service zone server set; or a quantity limit of traversals of the transmission event signal has been exceeded.

12. The method according to claim 9, further comprising:
receiving, from a prior waypoint, the one-way transmission event signal at a waypoint along the topology propagation path, and
deducting traversal energy from the event signal, wherein the deducted traversal energy corresponds to distance between the waypoint and the prior waypoint.

13. The method according to claim 8, wherein the event signal corresponds to a cross-zone-server traversal event of a virtual object in the service zone server set.

14. One or more non-transitory computer readable media comprising computer readable instructions which, when executed, configure a data processing system to perform:
the topology propagation path is based on a preset propagation parameter of the event signal,
the topology propagation path is a propagation path from the first zone server to a second zone server in the service zone server set, wherein the second zone server is specified by the first zone server, and
the preset propagation parameter indicates at least one of a propagation direction or a propagation mode of the event signal; and
transmitting the event signal from the first zone server to the second zone server along the topology propagation path.

15. The computer readable media according to claim 14 comprising computer readable instructions, which, when executed, further configure the data processing system to perform:
configuring, based on the event signal having a specified propagation direction, a type of the event signal;
configuring, based on the type of the event signal, a preset propagation parameter; and
determining, based on the preset propagation parameter, a topology propagation path of the event signal in the service zone server set.

16. The computer readable media according to claim 15, wherein the event signal is a diffusion event signal and wherein the computer readable instructions, when executed, further configure the data processing system to configure the preset propagation parameter by:
configuring an initial energy value and a termination threshold of the event signal, wherein:
the initial energy value represents an initial value of the virtual energy,
virtual energy of the diffusion event signal decreases as propagation distance increases, and
the termination threshold is an energy threshold, wherein the event signal stops propagating when the virtual energy does not satisfy the termination threshold.

17. The computer readable media according to claim 15, wherein the event signal is a one-way transmission event signal, and wherein configuring a preset propagation parameter further comprises:
determining an initial propagation direction and a traversal path information of the event signal, wherein:
traversal energy of the event signal decreases as propagation distance increases,
the initial propagation direction is specified by the first zone server, and,
the traversal path information represents a change rule of a propagation direction in propagation of the event signal.

18. A system, comprising:
a processor; and
memory storing computer readable instructions which, when executed, configure the system to perform:
determining, for an event signal originating from a first zone server in a service zone server set, a topology propagation path of the event signal in the service zone server set, wherein:
the topology propagation path is based on a preset propagation parameter of the event signal,
the topology propagation path is a propagation path from the first zone server to a second zone server in the service zone server set, wherein the second zone server is specified by the first zone server, and
the preset propagation parameter indicates at least one of a propagation direction or a propagation mode of the event signal; and
transmitting the event signal from the first zone server to the second zone server along the topology propagation path.

19. The system according to claim 18, wherein the computer readable instructions, when executed, further configure the system to perform:
configuring, based on the event signal having a specified propagation direction, a type of the event signal;
configuring, based on the type of the event signal, a preset propagation parameter; and
determining, based on the preset propagation parameter, a topology propagation path of the event signal in the service zone server set.

20. The system according to claim 19, wherein the event signal is a one-way transmission signal, and wherein configuring the preset propagation parameter further comprises:
determining an initial propagation direction and a traversal path information of the event signal, wherein:
traversal energy of the event signal decreases as propagation distance increases,
the initial propagation direction is specified by the first zone server, and,
the traversal path information represents a change rule of a propagation direction in propagation of the event signal.
